(19) United States
(12) Patent Application Publication
(10) Pub. No.: US 2015/0319186 A1
(43) Pub. Date: Nov. 5, 2015

(54) METHOD AND SYSTEM FOR DETECTING IRREGULARITIES AND VULNERABILITIES IN DEDICATED HOSTING ENVIRONMENTS

(71) Applicant: Intuit Inc., Mountain View, CA (US)

(72) Inventors: M. Shannon Lietz, San Marcos, CA (US); Luis Felipe Cabrera, Bellevue, WA (US)

(73) Assignee: INTUIT INC., Mountain View, CA (US)

(21) Appl. No.: 14/266,018

(22) Filed: Apr. 30, 2014

(51) Int. Cl. H04L 29/06

(52) U.S. Cl. CPC H04L 63/1433

(57) ABSTRACT

A dedicated hosting environment is provided and a requirement is imposed that each virtual asset deployed in the dedicated hosting environment include one or more required virtual asset characteristics. Each virtual asset deployed in the dedicated hosting environment is then provided virtual asset characteristic certification data indicating that the virtual asset includes the one or more required virtual asset characteristics. A virtual asset monitoring system then monitors each virtual asset deployed in the dedicated hosting environment to ensure that each virtual asset in the dedicated hosting environment includes the required virtual asset characteristic certification data. If a virtual asset is identified in the dedicated hosting environment that does not include the required virtual asset characteristic certification data, an alert is provided to one or more entities of the non-compliant virtual asset.

### BACKGROUND

As various forms of distributed computing, such as cloud computing, have come to dominate the computing landscape, security has become a bottleneck issue that currently prevents the complete migration of various capabilities and systems associated with sensitive data, such as financial data, to cloud-based infrastructures, and/or other distributive computing models. This is because many owners and operators of data centers that provide access to data and other resources are extremely hesitant to allow their data and resources to be accessed, processed, and/or otherwise used, by virtual assets in the cloud.

In a cloud computing environment, various virtual assets, such as, but not limited to, virtual machine instances, data stores, and services, are created, launched, or instantiated, in the cloud for use by an “owner” of the virtual asset, herein also referred to as a user of the virtual asset.

Herein the terms “owner” and “user” of a virtual asset include, but are not limited to, applications, systems, and sub-systems of software and/or hardware, as well as persons or entities associated with an account, or other identity, through which the virtual asset is purchased, approved managed, used, and/or created.

In order to provide a higher level of security for some of their customers, some cloud computing infrastructure providers allow users to purchase, or otherwise reserve, dedicated hosting environments that can only be used by that user. Typically these dedicated hosting environments take the form of portions of one or more hardware systems, processing systems, and/or other assets, that are solely dedicated, e.g., only to be used to support, virtual assets owned by the user/customer purchasing, or reserving, the dedicated hosting environment. Consequently, in one specific illustrative example, a user of a cloud computing infrastructure may purchase dedicated hardware servers that are to be used only to support virtual assets, such as virtual server instances, owned by that user.

In theory, the use of dedicated hosting environments can provide a cloud infrastructure customer dealing with sensitive data, such as financial data, the elevated security, and isolation, they require to ensure the security of their data. However, in order for dedicated hosting environments to provide this level of security, it must be positively established that the virtual assets deployed in the dedicated hosting environment are only virtual assets controlled, i.e., owned, by the user and that those virtual assets have the operational and security characteristics and features the user requires.

Unfortunately, using currently available dedicated hosting environments there is significant opportunity for virtual assets not controlled by the user, and/or not having the operational and security characteristics and features the user requires, to find their way into the user's dedicated hosting environment. In some cases, the virtual assets not controlled by the user, and/or not having the operational and security characteristics and features the user requires, find their way into the dedicated hosting environment via human error and/or insufficient monitoring. In other cases, the virtual assets not controlled by the user, and/or not having the operational and security characteristics and features the user requires, are introduced into the dedicated hosting environment by third parties with malicious intent. Either way, the existence of virtual assets not controlled by the user, and/or not having the operational and security characteristics and features the user requires, in a dedicated hosting environment defeats the purpose of the dedicated hosting environment and represents a security vulnerability.

What is needed is a method and system for automatically monitoring the virtual assets deployed in a dedicated hosting environment to positively establish that the virtual assets deployed in the dedicated hosting environment are only virtual assets controlled by a designated owner/user of the dedicated hosting environment and that those virtual assets have the operational and security characteristics and features the designated owner/user requires.

### SUMMARY

In accordance with one embodiment, a method and system for detecting irregularities and vulnerabilities in dedicated hosting environments includes providing a dedicated hosting environment. In one embodiment, one or more required virtual asset characteristics that are required to be associated with all virtual assets deployed in the dedicated hosting environment are defined. In one embodiment, required virtual asset characteristic certification data is generated indicating that a virtual asset includes the one or more required virtual asset characteristics. In one embodiment, each virtual asset deployed in the dedicated hosting environment is provided the required virtual asset characteristic certification data indicating that the virtual asset includes the one or more required virtual asset characteristics.

In one embodiment, a virtual asset monitoring system is provided that is capable of obtaining and/or reading the required virtual asset characteristic certification data. In one embodiment, the virtual asset monitoring system is used to monitor each virtual asset deployed in the dedicated hosting environment to ensure that each virtual asset in the dedicated hosting environment includes the required virtual asset characteristic certification data.

In one embodiment, if a virtual asset is identified in the dedicated hosting environment that does not include the required virtual asset characteristic certification data, that virtual assert is determined to be a non-compliant virtual asset and an alert is provided to one or more entities indicating the existence of the non-compliant virtual asset.

### BRIEF DESCRIPTION OF THE DRAWINGS

FIG. 1 is a functional block diagram showing the interaction of various components in a production environment for implementing one embodiment;

FIG. 2 is a high level and simplified functional diagram of a virtual asset creation template in accordance with one embodiment;

FIG. 3 is a more detailed functional block diagram showing the interaction of various components of a dedicated hosting environment of FIG. 1 for implementing one embodiment; and

FIG. 4 is a flow chart depicting a process for detecting irregularities and vulnerabilities in dedicated hosting environments in accordance with one embodiment.

Common reference numerals are used throughout the FIG.s and the detailed description to indicate like elements. One skilled in the art will readily recognize that the above FIG.s are examples and that other architectures, modes of operation, orders of operation and elements/functions can be provided and implemented without departing from the characteristics and features of the invention, as set forth in the claims.

### DETAILED DESCRIPTION

Embodiments will now be discussed with reference to the accompanying FIG.s, which depict one or more exemplary embodiments. Embodiments may be implemented in many different forms and should not be construed as limited to the embodiments set forth herein, shown in the FIG.s, and/or described below. Rather, these exemplary embodiments are provided to allow a complete disclosure that conveys the principles of the invention, as set forth in the claims, to those of skill in the art.

In one embodiment, a dedicated hosting environment, such as part of one or more hardware systems, is provided and a requirement is imposed that each virtual asset deployed in the dedicated hosting environment include one or more required virtual asset characteristics, such as the virtual asset being owned or controlled by a designated entity or the virtual asset being of a defined virtual asset class or function. In one embodiment, each virtual asset deployed in the dedicated hosting environment is then provided virtual asset characteristic certification data, such as metadata, indicating that the virtual asset includes the one or more required virtual asset characteristics. In one embodiment, a virtual asset monitoring system, such as a hypervisor, then monitors each virtual asset deployed in the dedicated hosting environment to ensure that each virtual asset in the dedicated hosting environment includes the required virtual asset characteristic certification data.

In one embodiment, if a virtual asset is identified in the dedicated hosting environment that does not include the required virtual asset characteristic certification data, that virtual assert is determined to be a non-compliant virtual asset and an alert is provided to one or more designated entities, such as a data center system operated by the owner of the dedicated hosting environment, of the non-compliant virtual asset.

In accordance with one embodiment, a method and system for detecting irregularities and vulnerabilities in dedicated hosting environments includes a process for detecting irregularities and vulnerabilities in dedicated hosting environments implemented, at least in part, in a production environment.

Herein, the term “production environment” includes the various components, or assets, used to deploy, implement, access, and use, a given application as that application is intended to be used. In various embodiments, production environments include multiple assets that are combined, communicatively coupled, virtually and/or physically connected, and/or associated with one another, to provide the production environment implementing the application.

As specific illustrative examples, the assets making up a given production environment can include, but are not limited to, one or more computing environments used to implement the application in the production environment such as a data center, a cloud computing environment, a dedicated hosting environment, and/or one or more other computing environments in which one or more assets used by the application in the production environment are implemented; one or more computing systems or computing entities used to implement the application in the production environment; one or more virtual assets used to implement the application in the production environment; one or more supervisory or control systems, such as hypervisors or other monitoring systems, used to monitor and control assets and/or components of the production environment; one or more communications channels for sending and receiving data used to implement the application in the production environment; one or more access control systems for limiting access to various components of the production environment, such as firewalls and gateways; one or more traffic and/or routing systems used to direct, control, and/or buffer, data traffic to components of the production environment, such as routers and switches; one or more communications endpoint proxy systems used to buffer, process, and/or direct data traffic, such as load balancers or buffers; one or more secure communication protocols and/or endpoints used to encrypt/decrypt data, such as Secure Sockets Layer (SSL) protocols, used to implement the application in the production environment; one or more databases used to store data in the production environment; one or more internal or external services used to implement the application in the production environment; one or more backend systems, such as backend servers or other hardware used to process data and implement the application in the production environment; one or more software systems used to implement the application in the production environment; and/or any other assets/components making up an actual production environment in which an application is deployed, implemented, accessed, and run, e.g., operated, as discussed herein, and/or as known in the art at the time of filing, and/or as developed after the time of filing.

As used herein, the term “computing environment” includes, but is not limited to, a logical or physical grouping of connected or networked computing systems and/or virtual assets using the same infrastructure and systems such as, but not limited to, hardware systems, software systems, and networking/communications systems. Typically, computing environments are either known environments, e.g., “trusted” environments, or unknown, e.g., “untrusted” environments.

Typically trusted computing environments are those where the assets, infrastructure, communication and networking systems, and security systems associated with the computing systems and/or virtual assets making up the trusted computing environment, are either under the control of, or known to, a party. A dedicated hosting environment is one example of a trusted computing environment. However, as discussed herein, a dedicated hosting environment is actually a trusted computing environment only if it can be positively established that the virtual assets deployed in the dedicated hosting environment are only virtual assets controlled by a designated owner/user of the dedicated hosting environment and that those virtual assets have the operational and security characteristics and features the designated owner/user requires.

In contrast, unknown, or untrusted computing environments are environments and systems where the assets, components, infrastructure, communication and networking systems, and security systems implemented and associated with the computing systems and/or virtual assets making up the untrusted computing environment, are not under the control of, and/or are not known by, a party, and/or are dynamically configured with new elements capable of being added that are unknown to the party. Consequently, any dedicated hosting environment where if it cannot be positively established that the virtual assets deployed in the dedicated hosting environment are only virtual assets controlled by a designated owner/user of the dedicated hosting environment and that those virtual assets have the operational and security characteristics and features the designated owner/user requires is, in fact, an untrusted computing environment.

It is often the case that to create, and/or deploy, and/or operate an application, data must be transferred between a first computing environment that is an untrusted computing environment and a trusted computing environment. However, in other situations a party may wish to transfer data between two trusted computing environments, and/or two untrusted computing environments.

As used herein, the terms “computing system” and “computing entity”, include, but are not limited to, a virtual asset; a server computing system; a workstation; a desktop computing system; a mobile computing system, including, but not limited to, smart phones, portable devices, and/or devices worn or carried by a user; a database system or storage cluster; a switching system; a router; any hardware system; any communications system; any form of proxy system; a gateway system; a firewall system; a load balancing system; or any device, subsystem, or mechanism that includes components that can execute all, or part, of any one of the processes and/or operations as described herein.

In addition, as used herein, the terms computing system and computing entity, can denote, but are not limited to, systems made up of multiple: virtual assets; server computing systems; workstations; desktop computing systems; mobile computing systems; database systems or storage clusters; switching systems; routers; hardware systems; communications systems; proxy systems; gateway systems; firewall systems; load balancing systems; or any devices that can be used to perform the processes and/or operations as described herein.

In accordance with one embodiment, a method and system for detecting irregularities and vulnerabilities in dedicated hosting environments includes a process for detecting irregularities and vulnerabilities in dedicated hosting environments implemented, at least in part, by one or more virtual assets in a cloud computing environment. In one embodiment, the cloud computing environment is part of, or is, the production environment of the application.

In various embodiments, one or more cloud computing environments are used to create, and/or deploy, and/or operate, an application that can be any form of cloud computing environment, such as, but not limited to, a public cloud; a private cloud; a virtual private network (VPN); a subnet; a Virtual Private Cloud (VPC); a sub-net or any security/communications grouping; or any other cloud-based infrastructure, sub-structure, or architecture, as discussed herein, and/or as known in the art at the time of filing, and/or as developed after the time of filing.

In many cases, a given application or service may utilize, and interface with, multiple cloud computing environments, such as multiple VPCs, in the course of being created, and/or deployed, and/or operated.

As used herein, the term “virtual asset” includes any virtualized entity or resource, and/or any virtualized part of an actual, or “bare metal” entity. In various embodiments, the virtual assets can be, but are not limited to, virtual machines, virtual servers, and instances implemented in a cloud computing environment; databases associated with a cloud computing environment, and/or implemented in a cloud computing environment; services associated with, and/or delivered through, a cloud computing environment; communications systems used with, part of, or provided through, a cloud computing environment; and/or any other virtualized assets and/or sub-systems of “bare metal” physical devices such as mobile devices, remote sensors, laptops, desktops, point-of-sale devices, ATMs, electronic voting machines, etc., located within a data center, within a cloud computing environment, and/or any other physical or logical location, as discussed herein, and/or as known/available in the art at the time of filing, and/or as developed/made available after the time of filing.

In various embodiments, any, or all, of the assets making up a given production environment discussed herein, and/or as known in the art at the time of filing, and/or as developed after the time of filing, can be implemented as virtual assets.

Some virtual assets are substantially similar to, or identical to, other virtual assets in that the virtual assets have the same, or similar, operational parameters such as, but not limited to, self-monitoring logic; self-reporting logic and capabilities; self-repairing logic and capabilities; the same, or similar, function, such as a computing processing function or a data store function; the same, or similar, connectivity and communication features; the same, or similar, storage capability allocated to the virtual assets; the same, or similar, processing capability allocated to the virtual assets; the same, or similar, hardware, allocated to the virtual assets; the same, or similar, software allocated to virtual assets; the same, or similar, security and/or virtual asset hardening features; and/or any combination of similar, or identical, functionality and/or operational parameters as discussed herein, and/or as known/available in the art at the time of filing, and/or as developed/made available after the time of filing.

Typically, virtual assets are created, or instantiated, using steps, instructions, processes, code, or “recipes” referred to herein as “virtual asset creation templates.” Typically, virtual assets that have the same, or similar, operational parameters are created using the same or similar “virtual asset creation templates.”

Examples of virtual asset creation templates include, but are not limited to, any tool and/or system for creating and managing a collection of related cloud resources. Illustrative examples of such a virtual asset creation template are any of the cloud formation templates/tools provided by Amazon Web Service (AWS), Rack Space, Joyent, and/or any other of the numerous cloud based infrastructure providers.

Other examples of virtual asset creation templates include, but are not limited to, any configuration management tool associated with, and/or used to create, virtual assets. One specific illustrative example of such a virtual asset creation template is a cookbook or recipe tool such as a Chef Recipe or system or any other fundamental element, or set of elements, used to override the default settings on a node within an infrastructure or architecture.

Other examples of virtual asset creation templates include, but are not limited to, any virtual appliance used to instantiate virtual assets. One specific illustrative example of such a virtual asset creation template is an Amazon Machine Image (AMI), and/or similar functionality provided by Amazon Web Service (AWS), Rack Space, Joyent, and/or any other of the numerous cloud based infrastructure providers.

Other examples of virtual asset creation templates include, but are not limited to, any appliance, or tool, or system, or framework, used to instantiate virtual assets as discussed herein, and/or as known/available in the art at the time of filing, and/or as developed/made available after the time of filing.

Herein virtual assets that have the same, or similar, operational parameters and are created by the same or similar virtual asset creation template are generically referred to as virtual assets of the same “class.” Examples of virtual asset classes include, but are not limited to, hosted and/or dedicated virtual assets; virtual machine classes; virtual server classes; virtual database or data store classes; self-monitoring virtual assets; specific types of instances instantiated in a cloud environment; application development process classes; and application classes.

As discussed herein, some owners/designated users of dedicated hosting environments require that each virtual asset deployed in their dedicated hosting environment include defined characteristics, including that each virtual asset deployed in their dedicated hosting environment be of the same type, or class, or have included features such as security hardening. Consequently, in many cases, in order to ensure a dedicated hosting environment is providing the security desired by the owner/designated user of the dedicated hosting environment, not only must it be positively established that the virtual assets deployed in the dedicated hosting environment are only virtual assets controlled by a designated owner/user of the dedicated hosting environment, but also that those virtual assets have the operational and security characteristics and features the designated owner/user requires, i.e., that those virtual assets are of the desired type, or class, of virtual asset.

In one embodiment, two or more assets, such as computing systems and/or virtual assets, and/or two or more computing environments, are connected by one or more communications channels including but not limited to, Secure Sockets Layer communications channels and various other secure communications channels, and/or distributed computing system networks, such as, but not limited to: a public cloud; a private cloud; a virtual private network (VPN); a subnet; any general network, communications network, or general network/communications network system; a combination of different network types; a public network; a private network; a satellite network; a cable network; or any other network capable of allowing communication between two or more assets, computing systems, and/or virtual assets, as discussed herein, and/or available or known at the time of filing, and/or as developed after the time of filing.

As used herein, the term “network” includes, but is not limited to, any network or network system such as, but not limited to, a peer-to-peer network, a hybrid peer-to-peer network, a Local Area Network (LAN), a Wide Area Network (WAN), a public network, such as the Internet, a private network, a cellular network, any general network, communications network, or general network/communications network system; a wireless network; a wired network; a wireless and wired combination network; a satellite network; a cable network; any combination of different network types; or any other system capable of allowing communication between two or more assets, virtual assets, and/or computing systems, whether available or known at the time of filing or as later developed.

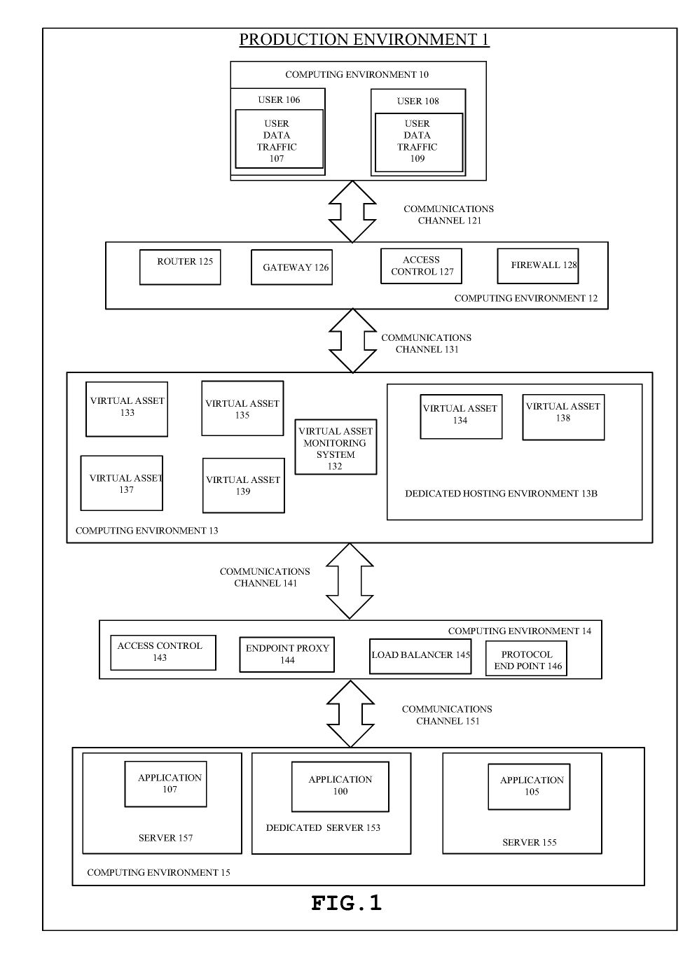

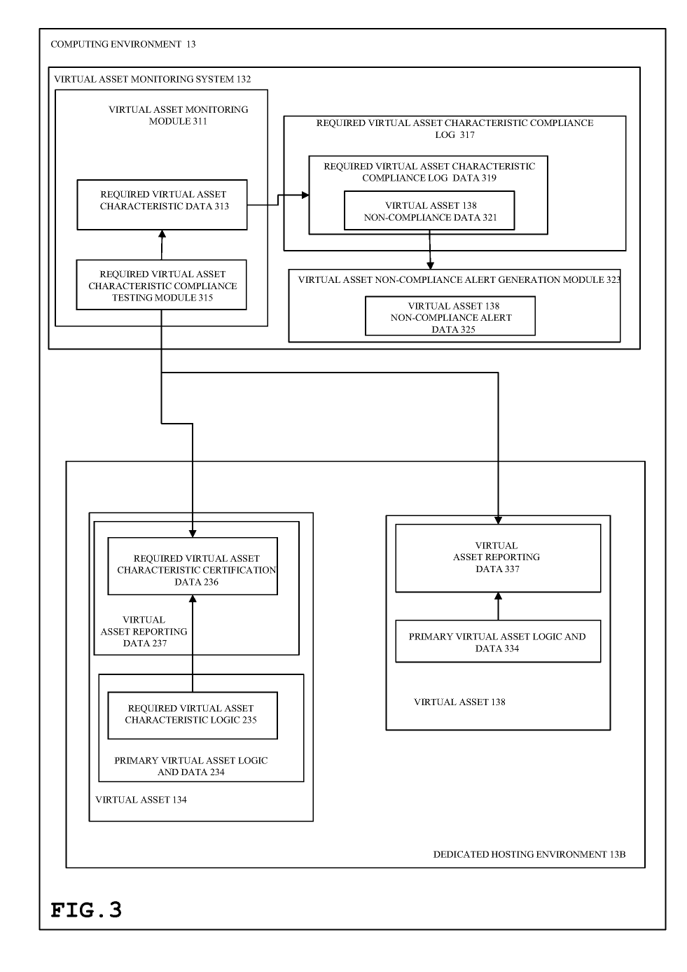

FIG. 1 is a functional diagram of the interaction of various elements associated with exemplary embodiments of the methods and systems for detecting irregularities and vulnerabilities in dedicated hosting environments discussed herein. FIG. 3 is a more detailed functional diagram of the interaction of various elements associated with one embodiment of the methods and systems for detecting irregularities and vulnerabilities in dedicated hosting environments discussed herein.

Of particular note, the various elements/assets in FIG. 1 and FIG. 3 are shown for illustrative purposes as being associated with production environment 1 and specific computing environments within production environment 1. However, the exemplary placement of the various elements/assets within these environments and systems in FIG. 1 and FIG. 3 is made for illustrative purposes only and, in various embodiments, any individual element/asset shown in FIG. 1 and FIG. 3, or combination of elements/assets shown in FIG. 1 and FIG. 3, can be implemented and/or deployed on any of one or more various computing environments or systems, and/or architectural or infrastructure components, such as one or more hardware systems, one or more software systems, one or more data centers, more or more clouds or cloud types, one or more third party service capabilities, or any other computing environments, architectural, and/or infrastructure components, as discussed herein, and/or as known in the art at the time of filing, and/or as developed/made available after the time of filing.

In addition, the elements shown in FIG. 1 and FIG. 3, and/or the computing environments, systems and architectural and/or infrastructure components, deploying the elements shown in FIG. 1 and FIG. 3, can be under the control of, or otherwise associated with, various parties or entities, or multiple parties or entities, such as, but not limited to, the owner of a data center, a party and/or entity providing all or a portion of a cloud-based computing environment, the owner or a provider of an application or service, the owner or provider of one or more resources, and/or any other party and/or entity providing one or more functions, and/or any other party and/or entity as discussed herein, and/or as known in the art at the time of filing, and/or as made known after the time of filing.

In one embodiment, a production environment is provided for implementing one or more applications. As noted above, FIG. 1 is a functional diagram of the interaction of various elements associated with one embodiment of a method and system for detecting irregularities and vulnerabilities in dedicated hosting environments discussed herein. In particular, FIG. 1 shows a given application, e.g., application 100 implemented in production environment 1 on dedicated server 153 and using various assets; a second application 105 implemented in production environment 1 on server 155 and a third application 107 implemented in production environment 1 on server 157. In this specific illustrative example, application 100 and server 153, second application 105 and server 155, and third application 107 and server 157, are shown in computing environment 15 of production environment 1.

As seen in FIG. 1, in this specific illustrative example, application 100 is to be implemented using, and including, assets such as, but not limited to, computing environments 10, 12, 13, 13B, 14, and 15, used to implement application 100 in production environment 1, such as a data center, a cloud computing environment, a dedicated hosting environment, and/or one or more other computing environments in which one or more assets and/or services used to implement application 100 in production environment 1 are deployed.

As seen in FIG. 1, production environment 1 includes computing environment 10 for providing user interaction with application 100 and production environment 1, for instance a local area network, or the Internet, that includes users 106 and 108 generating user data traffic 107 and 109, respectively, using one or more computing systems (not shown). As seen in FIG. 1, user data traffic 107 and 109 is provided to computing environment 12, such as an access layer or Internet Service Provider (ISP) service used to access application 100, via communications channel 121.

As seen in FIG. 1, production environment 1 includes computing environment 12 which, in turn, includes, as illustrative examples, one or more assets used to monitor and control assets and/or components of production environment 1, such as router 125, gateway 126, access control 127, and firewall 128. As seen in FIG. 1, in this specific illustrative example, computing environment 12 is commutatively coupled to computing environment 13 of production environment 1 by communications channel 131.

In the specific illustrative example of FIG. 1, computing environment 13 of production environment 1 is a cloud computing environment and includes representative virtual assets 133, 135, 137 and 139. In this specific illustrative example, computing environment 13 of production environment 1 also includes dedicated hosting environment 13B used to implement at least part of application 100.

In various embodiments, dedicated hosting environment 13B is a computing environment, or sub-computing environment, that has been purchased, provided, or otherwise reserved, to only be used by a defined dedicated hosting environment 13B user/dedicated hosting environment 13B owner. In various embodiments, dedicated hosting environment 13B is provided using portions of one or more hardware systems, processing systems, and/or other assets, such as dedicated server 153, that are solely dedicated, e.g., only to be used to support, virtual assets owned by the user/customer purchasing, or reserving, dedicated hosting environment 13B. Consequently, in one specific illustrative example, a user of a cloud computing infrastructure, such as computing environment 13, may purchase dedicated hardware servers, such as dedicated server 153, which are only to be used to support virtual assets, such as virtual server instances, owned by the dedicated hosting environment 13B user/dedicated hosting environment 13B owner.

As seen in FIG. 1, dedicated hosting environment 13B includes representative virtual asset 134 and representative virtual asset 138 that, in theory, in one embodiment, are owned and operated only by the dedicated hosting environment 13B user/dedicated hosting environment 13B owner.

In theory, the use of dedicated hosting environment 13B can provide a dedicated hosting environment 13B user/dedicated hosting environment 13B owner dealing with sensitive data, such as financial data, the elevated security, and isolation, they require to ensure the security of their data. However, in order for dedicated hosting environment 13B to provide this level of security, it must be positively established that the virtual assets, such as virtual asset 134 and virtual asset 138, deployed in dedicated hosting environment 13B are only virtual assets controlled, i.e., owned, by the dedicated hosting environment 13B user/dedicated hosting environment 13B owner, and/or that those virtual assets have the operational and security characteristics and features the dedicated hosting environment 13B user/dedicated hosting environment 13B owner requires.

Unfortunately, using currently available dedicated hosting environments there is significant opportunity for virtual assets not controlled by the dedicated hosting environment 13B user/dedicated hosting environment 13B owner, and/or not having the operational and security characteristics and features the dedicated hosting environment 13B user/dedicated hosting environment 13B owner requires, to find their way into dedicated hosting environment 13B. In some cases, these non-compliant virtual assets find their way into dedicated hosting environment 13B via human error and/or insufficient monitoring. In other cases, the non-compliant virtual assets are introduced into dedicated hosting environment 13B by third parties with malicious intent. Either way, the existence of non-complaint virtual assets deployed in dedicated hosting environment 13B defeats the purpose of dedicated hosting environment 13B and represents a security vulnerability.

As discussed below, to address this issue, a requirement is imposed that each virtual asset, such as virtual asset 134 and virtual asset 138, deployed in dedicated hosting environment 13B, include one or more required virtual asset characteristics, such as the virtual asset being owned or controlled by dedicated hosting environment 13B user/dedicated hosting environment 13B owner, and/or the virtual asset being of a defined virtual asset class or function. In one embodiment, each virtual asset, such as virtual asset 134 and virtual asset 138, deployed in dedicated hosting environment 13B is then provided virtual asset characteristic certification data, such as metadata, indicating that the virtual asset includes the one or more required virtual asset characteristics. In one embodiment, a virtual asset monitoring system, such as virtual asset monitoring system 132, then monitors each virtual asset, such as virtual asset 134 and virtual asset 138, deployed in dedicated hosting environment 13B to ensure that each virtual asset in dedicated hosting environment 13B includes the required virtual asset characteristic certification data.

In one embodiment, if a virtual asset, such as virtual asset 134 and virtual asset 138, is identified in dedicated hosting environment 13B that does not include the required virtual asset characteristic certification data, that virtual assert is determined to be a non-compliant virtual asset and an alert is provided to one or more designated entities, such as a data center system operated by dedicated hosting environment 13B user/dedicated hosting environment 13B owner, of the non-compliant virtual asset.

For illustrative purposes, virtual asset monitoring system 132 is shown in FIG. 1 as deployed in computing environment 13 of production environment 1. However, those of skill in the art will readily recognize that, in various embodiments, virtual asset monitoring system 132 can be deployed in any of the computing environments of production environment 1. In one embodiment, virtual asset monitoring system 132 is a hypervisor, or any other system, for monitoring and tracking virtual assets, implemented in hardware, software, or a combination of hardware and software. Virtual asset monitoring system 132 is discussed in more detail below.

In the specific illustrative example of FIG. 1, production environment 1 includes computing environment 14, such as an access control layer for limiting access to various components of the production environment, commutatively coupled to computing environment 13 by communications channel 141. In this specific illustrative example, computing environment 14 includes assets such as exemplary access control systems, e.g., one or more of access control 143, endpoint proxy 144, load balancer 145, and protocol endpoint 146.

As seen in the specific illustrative example of FIG. 1, production environment 1 includes computing environment 15, such as a data center or infrastructure provider environment, commutatively coupled to computing environment 14 by communications channel 151. In this specific illustrative example, computing environment 15 includes assets such dedicated server 153 associated with application 100, server 155, and server 157.

In one embodiment, a method and system for detecting irregularities and vulnerabilities in dedicated hosting environments includes providing a dedicated hosting environment.

In one embodiment, a dedicated hosting environment such as any of the dedicated hosting environments discussed herein, and/or as known in the art at the time of filing, and/or as are developed/become known after the time of filing, that provide a dedicated hosting environment user/dedicated hosting environment owner resources within a cloud computing environment that are allocated for use only by the dedicated hosting environment user/dedicated hosting environment owner is provided.

Dedicated hosting environments are typically desired to provide a higher level of security. Consequently, some cloud computing infrastructure providers allow customers to purchase, or otherwise reserve, dedicated hosting environments that can only be used by that dedicated hosting environment user/dedicated hosting environment owner.

Typically dedicated hosting environments take the form of portions of one or more hardware systems, processing systems, and/or other assets, which are solely dedicated, e.g., only to be used to support, virtual assets owned by the dedicated hosting environment user/dedicated hosting environment owner. Consequently, in one specific illustrative example, a user of a cloud computing infrastructure may purchase dedicated hardware servers that are to be used only to support virtual assets, such as virtual server instances, owned by that user.

In theory, the use of dedicated hosting environments can provide a cloud infrastructure user dealing with sensitive data, such as financial data, the elevated security, and isolation, they require to ensure the security of their data. However, in order for dedicated hosting environments to provide this level of security, it must be positively established that the virtual assets deployed in the dedicated hosting environment are only virtual assets controlled, i.e., owned, by the dedicated hosting environment user/dedicated hosting environment owner, and/or that those virtual assets have the operational and security characteristics and features the dedicated hosting environment user/dedicated hosting environment owner requires.

Unfortunately, using currently available dedicated hosting environments, there is significant opportunity for virtual assets not controlled by the dedicated hosting environment user/dedicated hosting environment owner, and/or not having the operational and security characteristics and features the dedicated hosting environment user/dedicated hosting environment owner requires, to find their way into the dedicated hosting environment user's/dedicated hosting environment owner's dedicated hosting environment.

In some cases, the non-compliant virtual assets not controlled by the dedicated hosting environment user/dedicated hosting environment owner, and/or not having the operational and security characteristics and features the dedicated hosting environment user/dedicated hosting environment owner requires, find their way into the dedicated hosting environment via human error and/or insufficient monitoring. In other cases, the non-compliant virtual assets not controlled by the dedicated hosting environment user/dedicated hosting environment owner, and/or not having the operational and security characteristics and features the dedicated hosting environment user/dedicated hosting environment owner requires, are introduced into the dedicated hosting environment by third parties with malicious intent.

Either way, the existence of virtual assets not controlled by the dedicated hosting environment user/dedicated hosting environment owner, and/or not having the operational and security characteristics and features the dedicated hosting environment user/dedicated hosting environment owner requires, in the dedicated hosting environment typically defeats the purpose of the dedicated hosting environment and represents a security vulnerability.

To address this issue, in one embodiment, one or more required virtual asset characteristics that are required to be associated with all virtual assets deployed in the dedicated hosting environment are defined.

In various embodiments, the one or more required virtual asset characteristics can include, but are not limited to, the required virtual asset characteristic that the virtual assets be hosted virtual assets dedicated for use by a defined entity. Using this required virtual asset characteristic, a dedicated hosting environment user/dedicated hosting environment owner can ensure that all virtual assets deployed in the dedicated hosting environment belong to, and/or are dedicated to, the dedicated hosting environment user/dedicated hosting environment owner.

In various embodiments, the one or more required virtual asset characteristics can include, but are not limited to, the required virtual asset characteristic that the virtual assets be of a defined virtual asset class. Using this required virtual asset characteristic, a dedicated hosting environment user/dedicated hosting environment owner can ensure that all virtual assets deployed in the dedicated hosting environment are of the desired class, such as a virtual machine, data storage related virtual asset, an access related virtual asset, etc.

In various embodiments, the one or more required virtual asset characteristics can include, but are not limited to, the required virtual asset characteristic that the virtual assets have a defined functionality. Using this required virtual asset characteristic, a dedicated hosting environment user/dedicated hosting environment owner can ensure that all virtual assets deployed in the dedicated hosting environment are of the desired function, such as data processing, data storage, etc.

In various embodiments, the one or more required virtual asset characteristics can include, but are not limited to, the required virtual asset characteristic that the virtual assets have one or more defined capabilities. Using this required virtual asset characteristic, a dedicated hosting environment user/dedicated hosting environment owner can ensure that all virtual assets deployed in the dedicated hosting environment have a desired capability, such as a self-monitoring capability, a self-reporting capability, a self-healing capability, a self-destruct or function/communication shutdown capability, etc.

In various embodiments, the one or more required virtual asset characteristics can include, but are not limited to, the required virtual asset characteristic that the virtual assets be hardened virtual assets. Using this required virtual asset characteristic, a dedicated hosting environment user/dedicated hosting environment owner can ensure that all virtual assets deployed in the dedicated hosting environment have a desired level of security hardening.

In various embodiments, the one or more required virtual asset characteristics can include, but are not limited to, the required virtual asset characteristic that the virtual assets be virtual assets instantiated to include one or more defined security features. Using this required virtual asset characteristic, a dedicated hosting environment user/dedicated hosting environment owner can ensure that all virtual assets deployed in the dedicated hosting environment have a desired threshold level, or type, of security features.

In various embodiments, the one or more required virtual asset characteristics can include any required virtual asset characteristic, and/or combination of required virtual asset characteristics, as discussed herein, and/or as known in the art at the time of filing, and/or as become available/known after the time of filing.

In one embodiment, required virtual asset characteristic certification data is generated. In one embodiment, the required virtual asset characteristic certification data is data to be included in compliant virtual assets indicating that the compliant virtual asset includes the one or more required virtual asset characteristics.

In one embodiment, the required virtual asset characteristic certification data generated is machine readable code that when accessed or activated indicates that the compliant virtual asset includes the one or more required virtual asset characteristics.

In one embodiment, each virtual asset deployed in the dedicated hosting environment is then provided the required virtual asset characteristic certification data indicating that the virtual asset includes the one or more required virtual asset characteristics.

In one embodiment, compliant virtual assets are instantiated for deployment in the dedicated hosting environment. In various embodiments the compliant virtual assets to be deployed in the dedicated hosting environment are any of the virtual assets discussed herein, and/or as known in the art at the time of filing, and/or as developed after the time of filing.

In one embodiment, each of the compliant virtual assets instantiated for deployment in the dedicated hosting environment is provided the required virtual asset characteristic certification data indicating that the virtual asset includes the one or more required virtual asset characteristics.

In one embodiment, each of the compliant virtual assets instantiated for deployment in the dedicated hosting environment is provided the required virtual asset characteristic certification data indicating that the virtual asset includes the one or more required virtual asset characteristics as metadata that can be accessed and read by the dedicated hosting environment user/dedicated hosting environment owner.

In one embodiment, each of the compliant virtual assets instantiated for deployment in the dedicated hosting environment is provided the required virtual asset characteristic certification data indicating that the virtual asset includes the one or more required virtual asset characteristics as part of virtual asset reporting data included in virtual asset reporting logic and data provided to the compliant virtual assets using a compliant virtual asset creation template.

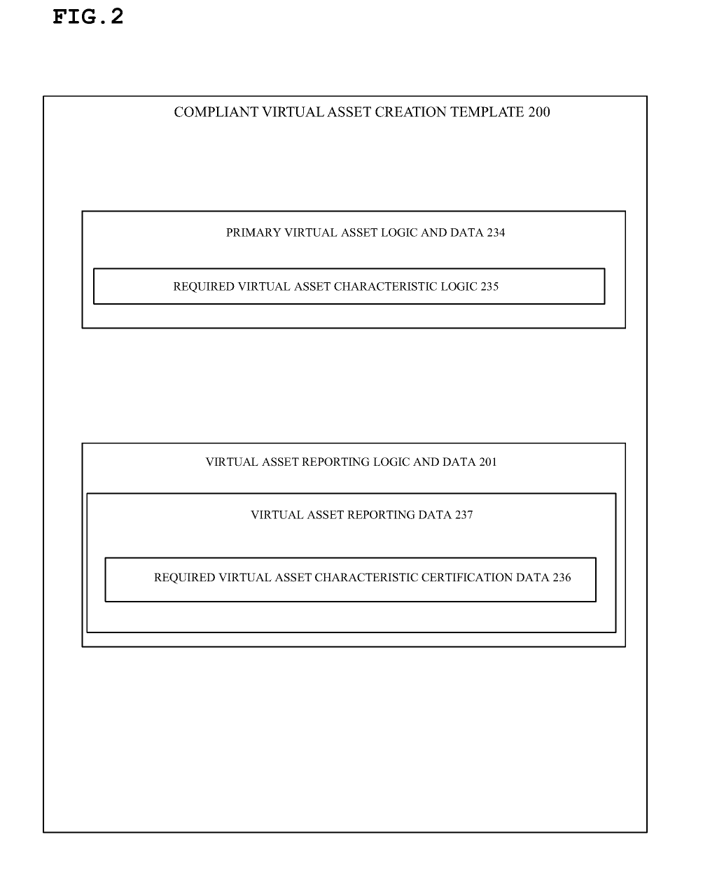

Referring to FIG. 2, an exemplary high level logic diagram of a compliant virtual asset creation template 200 is shown. As seen in FIG. 2 in one embodiment, compliant virtual asset creation template 200 includes primary virtual asset logic and data 234.

In one embodiment, primary virtual asset logic and data 234 includes logic and data, and instructions associated with the compliant virtual asset itself, and/or the normal functions and operations of the compliant virtual asset, and/or the operating environment of the compliant virtual asset, such as a cloud computing environment and/or one or more management systems for the cloud computing environment.

As specific illustrative examples, in various embodiments, primary virtual asset logic and data 234 includes, but is not limited to, one or more of, data indicating the compliant virtual asset's identification; data indicating the region associated with the compliant virtual asset; data indicating the availability zone associated with the compliant virtual asset; data representing and/or indicating software modules and code residing within, or assigned to, the compliant virtual asset; data indicating a number of software modules residing within, or associated with, the compliant virtual asset; data representing or indicating files and/or file names residing within, or assigned to, the compliant virtual asset; data representing and/or indicating the exact configuration of the compliant virtual asset; data indicating a boot sequence for the compliant virtual asset; any data provided by a hypervisor or virtualization layer associated with the compliant virtual asset; any data provided from a cloud control plane associated with the compliant virtual asset; any data provided by any management system associated with the computing environment of the compliant virtual asset; communications and data transfer logic associated with the compliant virtual asset, such as logic and instructions for providing “normal” communications channels and data transfer mechanisms to be used by the compliant virtual asset once the compliant virtual asset is instantiated, and/or deployed; and/or any combination of “inside” or “normal” operational virtual asset logic and data as discussed herein, and/or as known in the art at the time of filing, and/or as developed after the time of filing.

In one embodiment, using at least part of primary virtual asset logic and data 234, a compliant virtual asset can be instantiated, or launched, in a computing environment, such as a dedicated hosting environment.

As also seen in FIG. 2, primary virtual asset logic and data 234 includes required virtual asset characteristic logic 235. In various embodiments, depending on the required virtual asset characteristics defined and/or desired, required virtual asset characteristic logic 235 includes data indicating that the compliant virtual asset is a hosted virtual asset dedicated for use by the dedicated hosting environment user/dedicated hosting environment owner.

In various embodiments, depending on the required virtual asset characteristics defined and/or desired, required virtual asset characteristic logic 235 includes data indicating that the compliant virtual asset is of a defined virtual asset class, such as a virtual machine, data storage related virtual asset, an access related virtual asset, etc.

In various embodiments, depending on the required virtual asset characteristics defined and/or desired, required virtual asset characteristic logic 235 includes data indicating the compliant virtual asset has a defined functionality such as data processing, data storage, etc.

In various embodiments, depending on the required virtual asset characteristics defined and/or desired, required virtual asset characteristic logic 235 includes data indicating the compliant virtual asset has one or more defined capabilities such as a self-monitoring capability, a self-reporting capability, a self-healing capability, a self-destruct or function/communication shutdown capability, etc.

In various embodiments, depending on the required virtual asset characteristics defined and/or desired, required virtual asset characteristic logic 235 includes data indicating the compliant virtual asset has a desired level of security hardening.

In various embodiments, depending on the required virtual asset characteristics defined and/or desired, required virtual asset characteristic logic 235 includes data indicating the compliant virtual asset includes one or more defined security features, and/or a desired threshold level of security features.

In various embodiments, depending on the required virtual asset characteristics defined and/or desired, required virtual asset characteristic logic 235 includes data indicating the compliant virtual asset includes any required virtual asset characteristic, and/or combination of required virtual asset characteristics, as discussed herein, and/or as known in the art at the time of filing, and/or as become available/known after the time of filing.

In one embodiment, compliant virtual asset creation template 200 includes virtual asset reporting logic and data 201. In one embodiment, virtual asset reporting logic and data 201 includes instructions and data for providing virtual asset reporting data 237; in one embodiment, to a virtual asset monitoring system.

In one embodiment, virtual asset reporting logic and data 201 includes instructions and data for providing virtual asset reporting data 237 as metadata associated with the compliant virtual assets.

In one embodiment, virtual asset reporting logic and data 201 includes instructions and data for providing virtual asset reporting data 237 as response data in response to the receipt of challenge data; in one embodiment provided from a virtual asset monitoring system.

In one embodiment, virtual asset reporting logic and data 201 includes instructions and data for generating and activating a self-reporting communications door in response to the receipt of challenge data provided from a virtual asset monitoring system and then providing virtual asset reporting data 237 using the self-reporting communications door.

As seen in FIG. 2, virtual asset reporting data 237 includes required virtual asset characteristic certification data 236. In one embodiment, required virtual asset characteristic certification data 236 is data included in compliant virtual assets indicating that the compliant virtual asset includes the one or more required virtual asset characteristics.

In one embodiment, the required virtual asset characteristic certification data 236 is machine readable code that when accessed or activated indicates that the compliant virtual asset includes the one or more required virtual asset characteristics.

In one embodiment, a virtual asset monitoring system is provided that is capable of obtaining and/or reading the required virtual asset characteristic certification data.

In one embodiment, the virtual asset monitoring system is used to monitor each virtual asset deployed in the dedicated hosting environment to ensure that each virtual asset in the dedicated hosting environment includes the required virtual asset characteristic certification data, i.e., is a compliant virtual asset.

In one embodiment, the virtual asset monitoring system is implemented in the dedicated hosting environment in which the virtual assets are instantiated and deployed. In one embodiment, the virtual asset monitoring system is implemented in a computing environment that is distinct from the dedicated hosting environment in which the virtual assets are instantiated and deployed.

In one embodiment, the virtual asset monitoring system is implemented, at least in part, in a data center associated with the dedicated hosting environment user/dedicated hosting environment owner.

In various embodiments, the virtual asset monitoring system is implemented in software, hardware, and/or a combination of software and hardware.

In one embodiment, the virtual asset monitoring system is a hypervisor, or similar system, for monitoring and/or managing a computing environment and the assets associated with the computing environment.

In one embodiment, the virtual asset monitoring system is used to monitor each virtual asset deployed in the dedicated hosting environment to ensure that each virtual asset in the dedicated hosting environment includes the required virtual asset characteristic certification data.

In one embodiment, the virtual asset monitoring system monitors each virtual asset deployed in the dedicated hosting environment by checking metadata associated with the virtual assets in the dedicated hosting environment including the required virtual asset characteristic certification data.

In one embodiment, the virtual asset monitoring system monitors each virtual asset deployed in the dedicated hosting environment by generating a challenge for each virtual asset deployed in the dedicated hosting environment and receiving response data including the required virtual asset characteristic certification data.

In one embodiment, the virtual asset monitoring system monitors each virtual asset deployed in the dedicated hosting environment by any one of numerous methods, means, mechanisms, and systems known in the art for obtaining data related to a virtual asset, as discussed herein, and/or as known in the art at the time of filing, and/or as developed after the time of filing.

In one embodiment, the virtual asset monitoring system monitors each virtual asset deployed in the dedicated hosting environment on a relatively continuous basis. In one embodiment, the virtual asset monitoring system monitors each virtual asset deployed in the dedicated hosting environment on a defined periodic basis. In one embodiment, the virtual asset monitoring system monitors each virtual asset deployed in the dedicated hosting environment upon the occurrence of one or more trigger events, such as the instantiation of a new virtual asset in the dedicated hosting environment or in response to a call from a virtual asset in the dedicated hosting environment. In one embodiment, the virtual asset monitoring system monitors each virtual asset on an on demand basis.

In one embodiment, the virtual asset monitoring system monitoring each virtual asset deployed in the dedicated hosting environment results in the creation of a required virtual asset characteristic compliance log that includes required virtual asset characteristic compliance log data. In one embodiment, the required virtual asset characteristic compliance log data indicates the compliance or non-compliance state of each virtual asset deployed in the dedicated hosting environment.

In one embodiment, the required virtual asset characteristic compliance log data is then analyzed on a relatively continuous, periodic, trigger event occurrence, or on-demand basis.

In one embodiment, if a virtual asset is identified in the dedicated hosting environment that does not include the required virtual asset characteristic certification data, that virtual assert is determined to be a non-compliant virtual asset and an alert is provided to one or more entities of the non-compliant virtual asset.

FIG. 3 is a more detailed functional block diagram showing the interaction of various components of an example of dedicated hosting environment 13B of FIG. 1 for implementing one embodiment.

As seen in FIG. 3, virtual asset 134 and virtual asset 138 are shown instantiated in dedicated hosting environment 13B. In this specific illustrative example, it is stipulated that virtual asset 134 is a compliant virtual asset having been instantiated using a compliant virtual asset template, such as compliant virtual asset template 200 of FIG. 2. In this specific illustrative example, it is further stipulated that virtual asset 138 is a non-compliant virtual asset.

Consequently, as seen in FIG. 3, compliant virtual asset 134 includes required virtual asset characteristic logic 235 as part of primary virtual asset logic and data 234. In contrast, non-compliant virtual asset 138 does not include the required virtual asset characteristic logic as part of primary virtual asset logic and data 334. Given that compliant virtual asset 134 includes required virtual asset characteristic logic 235, virtual asset reporting data 237 for compliant virtual asset 134 includes required virtual asset characteristic certification data 236. In contrast, given that non-compliant virtual asset 138 does not include required virtual asset characteristic logic, virtual asset reporting data 337 for non-compliant virtual asset 138 does not include any required virtual asset characteristic certification data.

Also seen in FIG. 3 is virtual asset monitoring system 132 deployed, at least in part, in this specific illustrative example, in computing environment 13.

As seen in FIG. 3, virtual asset monitoring system 132 includes a virtual asset monitoring module 311 for obtaining virtual asset reporting data 237 from virtual asset 134 and virtual asset reporting data 337 from virtual asset 138 in dedicated hosting environment 13B.

In one embodiment, virtual asset monitoring module 311 includes required virtual asset characteristic compliance testing module 315 which receives virtual asset reporting data 237 from virtual asset 134 and virtual asset reporting data 337 from virtual asset 138 and analyzes or compares virtual asset reporting data 237 from virtual asset 134 and virtual asset reporting data 337 from virtual asset 138 with required virtual asset characteristic data 313 which indicates the required virtual asset characteristic certification data that should be present in virtual asset reporting data 237 from virtual asset 134 and virtual asset reporting data 337 from virtual asset 138.

In one embodiment, if required virtual asset characteristic certification data in compliance with required virtual asset characteristic data 313 is not found in virtual asset reporting data 237 from virtual asset 134, and/or virtual asset reporting data 337 from virtual asset 138, then the virtual asset associated with the virtual asset reporting data not including the required virtual asset characteristic certification data is identified as a non-compliant virtual asset.

As noted, in the specific illustrative example of FIG. 3 compliant virtual asset 134 includes required virtual asset characteristic certification data 236 and non-compliant virtual asset 138 does not include required virtual asset characteristic logic. Consequently, in this specific illustrative example, non-compliant virtual asset 138 is identified as a non-compliant virtual asset by virtual asset monitoring module 311.

As seen in FIG. 3, in one embodiment, virtual asset monitoring module 132 includes required virtual asset characteristic compliance log 317. In one embodiment, required virtual asset characteristic compliance log 317 includes required virtual asset characteristic compliance log data 319 indicating the compliance state of the virtual assets deployed in dedicated hosting environment 13B.

In the specific illustrative example of FIG. 3, since non-compliant virtual asset 138 was identified as a non-compliant virtual asset by virtual asset monitoring module 311, required virtual asset characteristic compliance log data 319 includes virtual asset 138 non-compliance data 321 indicating non-compliant virtual asset 138 was identified as a non-compliant virtual asset.

In one embodiment, an alert is automatically generated by virtual asset non-compliance alert generation module 323 of virtual asset monitoring system 132 whenever a virtual asset deployed in dedicated hosting environment 132 is identified.

In The specific illustrative example of FIG. 3, virtual asset 138 non-compliance data 321 triggers virtual asset non-compliance alert generation module 323 to generate virtual asset 138 non-compliance alert data 325. In one embodiment, virtual asset 138 non-compliance alert data 325 is then provided to one or more designated parties or entities, such as the dedicated hosting environment user/dedicated hosting environment owner.

Using the methods and systems for detecting irregularities and vulnerabilities in dedicated hosting environments discussed herein, virtual assets deployed in a dedicated hosting environment are automatically monitored to positively establish that the virtual assets deployed in the dedicated hosting environment are only virtual assets controlled by a designated owner/user of the dedicated hosting environment and that those virtual assets have the operational and security characteristics and features the designated dedicated hosting environment owner/user requires. Consequently, using the methods and systems for detecting irregularities and vulnerabilities in dedicated hosting environments discussed herein, a designated owner/user of a dedicated hosting environment can ensure his or her dedicated hosting environment is providing the security level required and is providing the full benefits associated with, and expected from, dedicated hosting environments.

### Process

In one embodiment, a process for detecting irregularities and vulnerabilities in dedicated hosting environments includes providing a dedicated hosting environment. In one embodiment, one or more required virtual asset characteristics that are required to be associated with all virtual assets deployed in the dedicated hosting environment are defined. In one embodiment, required virtual asset characteristic certification data is generated indicating that a virtual asset includes the one or more required virtual asset characteristics. In one embodiment, each virtual asset deployed in the dedicated hosting environment is provided the required virtual asset characteristic certification data indicating that the virtual asset includes the one or more required virtual asset characteristics.

In one embodiment, a virtual asset monitoring system is provided that is capable of obtaining and/or reading the required virtual asset characteristic certification data. In one embodiment, the virtual asset monitoring system is used to monitor each virtual asset deployed in the dedicated hosting environment to ensure that each virtual asset in the dedicated hosting environment includes the required virtual asset characteristic certification data.

In one embodiment, if a virtual asset is identified in the dedicated hosting environment that does not include the required virtual asset characteristic certification data, that virtual assert is determined to be a non-compliant virtual asset and an alert is provided to one or more entities indicating the existence of the non-compliant virtual asset.

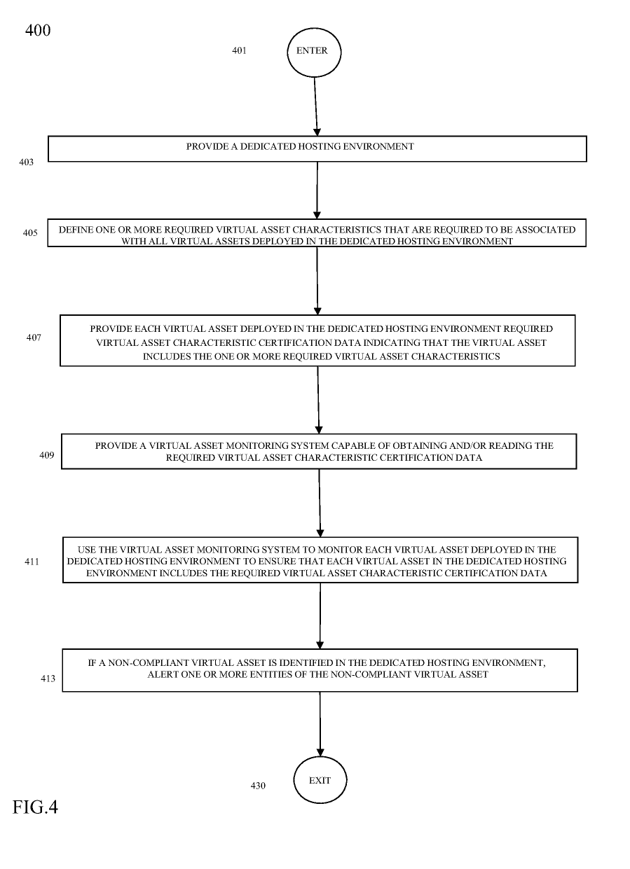

FIG. 4 is a flow chart of a process 400 for detecting irregularities and vulnerabilities in dedicated hosting environments in accordance with one embodiment. In one embodiment, process 400 for detecting irregularities and vulnerabilities in dedicated hosting environments begins at ENTER OPERATION 401 of FIG. 4 and process flow proceeds to PROVIDE A DEDICATED HOSTING ENVIRONMENT OPERATION 403.

In one embodiment, at PROVIDE A DEDICATED HOSTING ENVIRONMENT OPERATION 403 a dedicated hosting environment is provided.

In one embodiment, a dedicated hosting environment such as any of the dedicated hosting environments discussed herein, and/or as known in the art at the time of filing, and/or as are developed/become known after the time of filing, that provide a dedicated hosting environment user/dedicated hosting environment owner resources within a cloud computing environment that are allocated for use only by the dedicated hosting environment user/dedicated hosting environment owner is provided at PROVIDE A DEDICATED HOSTING ENVIRONMENT OPERATION 403.

Dedicated hosting environments are typically desired to provide a higher level of security. Consequently, some cloud computing infrastructure providers allow customers to purchase, or otherwise reserve, dedicated hosting environments that can only be used by that dedicated hosting environment user/dedicated hosting environment owner.

In various embodiments, the dedicated hosting environment of PROVIDE A DEDICATED HOSTING ENVIRONMENT OPERATION 403 is in the form of portions of one or more hardware systems, processing systems, and/or other assets, which are solely dedicated, e.g., only to be used to support, virtual assets owned by the dedicated hosting environment user/dedicated hosting environment owner. Consequently, in one specific illustrative example, a user of a cloud computing infrastructure may purchase dedicated hardware servers that are to be used only to support virtual assets, such as virtual server instances, owned by that user.

In theory, the use of dedicated hosting environments can provide a cloud infrastructure user dealing with sensitive data, such as financial data, the elevated security, and isolation, they require to ensure the security of their data. However, in order for dedicated hosting environments to provide this level of security, it must be positively established that the virtual assets deployed in the dedicated hosting environment are only virtual assets controlled, i.e., owned, by the dedicated hosting environment user/dedicated hosting environment owner, and/or that those virtual assets have the operational and security characteristics and features the dedicated hosting environment user/dedicated hosting environment owner requires.

Unfortunately, using currently available dedicated hosting environments, there is significant opportunity for virtual assets not controlled by the dedicated hosting environment user/dedicated hosting environment owner, and/or not having the operational and security characteristics and features the dedicated hosting environment user/dedicated hosting environment owner requires, to find their way into the dedicated hosting environment user's/dedicated hosting environment owner's dedicated hosting environment.

In some cases, the non-compliant virtual assets not controlled by the dedicated hosting environment user/dedicated hosting environment owner, and/or not having the operational and security characteristics and features the dedicated hosting environment user/dedicated hosting environment owner requires, find their way into the dedicated hosting environment via human error and/or insufficient monitoring. In other cases, the non-compliant virtual assets not controlled by the dedicated hosting environment user/dedicated hosting environment owner, and/or not having the operational and security characteristics and features the dedicated hosting environment user/dedicated hosting environment owner requires, are introduced into the dedicated hosting environment by third parties with malicious intent.

Either way, the existence of virtual assets not controlled by the dedicated hosting environment user/dedicated hosting environment owner, and/or not having the operational and security characteristics and features the dedicated hosting environment user/dedicated hosting environment owner requires, in a dedicated hosting environment typically defeats the purpose of the dedicated hosting environment and represents a security vulnerability.

In one embodiment, once a dedicated hosting environment is provided at PROVIDE A DEDICATED HOSTING ENVIRONMENT OPERATION 403, process flow proceeds to DEFINE ONE OR MORE REQUIRED VIRTUAL ASSET CHARACTERISTICS THAT ARE REQUIRED TO BE ASSOCIATED WITH ALL VIRTUAL ASSETS DEPLOYED IN THE DEDICATED HOSTING ENVIRONMENT OPERATION 405.

In one embodiment, at DEFINE ONE OR MORE REQUIRED VIRTUAL ASSET CHARACTERISTICS THAT ARE REQUIRED TO BE ASSOCIATED WITH ALL VIRTUAL ASSETS DEPLOYED IN THE DEDICATED HOSTING ENVIRONMENT OPERATION 405, one or more required virtual asset characteristics that are required to be associated with all virtual assets deployed in the dedicated hosting environment are defined and required virtual asset characteristic certification data is generated.

In various embodiments, the one or more required virtual asset characteristics of DEFINE ONE OR MORE REQUIRED VIRTUAL ASSET CHARACTERISTICS THAT ARE REQUIRED TO BE ASSOCIATED WITH ALL VIRTUAL ASSETS DEPLOYED IN THE DEDICATED HOSTING ENVIRONMENT OPERATION 405 can include, but are not limited to, the required virtual asset characteristic that the virtual assets be hosted virtual assets dedicated for use by a defined entity. Using this required virtual asset characteristic, a dedicated hosting environment user/dedicated hosting environment owner can ensure that all virtual assets deployed in the dedicated hosting environment belong to, and/or are dedicated to, the dedicated hosting environment user/dedicated hosting environment owner.

In various embodiments, the one or more required virtual asset characteristics of DEFINE ONE OR MORE REQUIRED VIRTUAL ASSET CHARACTERISTICS THAT ARE REQUIRED TO BE ASSOCIATED WITH ALL VIRTUAL ASSETS DEPLOYED IN THE DEDICATED HOSTING ENVIRONMENT OPERATION 405 can include, but are not limited to, the required virtual asset characteristic that the virtual assets be of a defined virtual asset class. Using this required virtual asset characteristic, a dedicated hosting environment user/dedicated hosting environment owner can ensure that all virtual assets deployed in the dedicated hosting environment are of the desired class, such as a virtual machine, data storage related virtual asset, an access related virtual asset, etc.

In various embodiments, the one or more required virtual asset characteristics of DEFINE ONE OR MORE REQUIRED VIRTUAL ASSET CHARACTERISTICS THAT ARE REQUIRED TO BE ASSOCIATED WITH ALL VIRTUAL ASSETS DEPLOYED IN THE DEDICATED HOSTING ENVIRONMENT OPERATION 405 can include, but are not limited to, the required virtual asset characteristic that the virtual assets have a defined functionality. Using this required virtual asset characteristic, a dedicated hosting environment user/dedicated hosting environment owner can ensure that all virtual assets deployed in the dedicated hosting environment are of the desired function, such as data processing, data storage, etc.

In various embodiments, the one or more required virtual asset characteristics of DEFINE ONE OR MORE REQUIRED VIRTUAL ASSET CHARACTERISTICS THAT ARE REQUIRED TO BE ASSOCIATED WITH ALL VIRTUAL ASSETS DEPLOYED IN THE DEDICATED HOSTING ENVIRONMENT OPERATION 405 can include, but are not limited to, the required virtual asset characteristic that the virtual assets have one or more defined capabilities. Using this required virtual asset characteristic, a dedicated hosting environment user/dedicated hosting environment owner can ensure that all virtual assets deployed in the dedicated hosting environment have a desired capability, such as a self-monitoring capability, a self-reporting capability, a self-healing capability, a self-destruct or function/communication shutdown capability, etc.

In various embodiments, the one or more required virtual asset characteristics of DEFINE ONE OR MORE REQUIRED VIRTUAL ASSET CHARACTERISTICS THAT ARE REQUIRED TO BE ASSOCIATED WITH ALL VIRTUAL ASSETS DEPLOYED IN THE DEDICATED HOSTING ENVIRONMENT OPERATION 405 can include, but are not limited to, the required virtual asset characteristic that the virtual assets be hardened virtual assets. Using this required virtual asset characteristic, a dedicated hosting environment user/dedicated hosting environment owner can ensure that all virtual assets deployed in the dedicated hosting environment have a desired level of security hardening.

In various embodiments, the one or more required virtual asset characteristics of DEFINE ONE OR MORE REQUIRED VIRTUAL ASSET CHARACTERISTICS THAT ARE REQUIRED TO BE ASSOCIATED WITH ALL VIRTUAL ASSETS DEPLOYED IN THE DEDICATED HOSTING ENVIRONMENT OPERATION 405 can include, but are not limited to, the required virtual asset characteristic that the virtual assets be virtual assets instantiated to include one or more defined security features. Using this required virtual asset characteristic, a dedicated hosting environment user/dedicated hosting environment owner can ensure that all virtual assets deployed in the dedicated hosting environment have a desired threshold level, or type, of security features.

In various embodiments, the one or more required virtual asset characteristics of DEFINE ONE OR MORE REQUIRED VIRTUAL ASSET CHARACTERISTICS THAT ARE REQUIRED TO BE ASSOCIATED WITH ALL VIRTUAL ASSETS DEPLOYED IN THE DEDICATED HOSTING ENVIRONMENT OPERATION 405 can include any required virtual asset characteristic, and/or combination of required virtual asset characteristics, as discussed herein, and/or as known in the art at the time of filing, and/or as become available/known after the time of filing.

In one embodiment, once one or more required virtual asset characteristics that are required to be associated with all virtual assets deployed in the dedicated hosting environment are defined, required virtual asset characteristic certification data is generated at DEFINE ONE OR MORE REQUIRED VIRTUAL ASSET CHARACTERISTICS THAT ARE REQUIRED TO BE ASSOCIATED WITH ALL VIRTUAL ASSETS DEPLOYED IN THE DEDICATED HOSTING ENVIRONMENT OPERATION 405.

In one embodiment, the required virtual asset characteristic certification data of DEFINE ONE OR MORE REQUIRED VIRTUAL ASSET CHARACTERISTICS THAT ARE REQUIRED TO BE ASSOCIATED WITH ALL VIRTUAL ASSETS DEPLOYED IN THE DEDICATED HOSTING ENVIRONMENT OPERATION 405 is data to be included in compliant virtual assets indicating that the compliant virtual asset includes the one or more required virtual asset characteristics.

In one embodiment, the required virtual asset characteristic certification data generated at DEFINE ONE OR MORE REQUIRED VIRTUAL ASSET CHARACTERISTICS THAT ARE REQUIRED TO BE ASSOCIATED WITH ALL VIRTUAL ASSETS DEPLOYED IN THE DEDICATED HOSTING ENVIRONMENT OPERATION 405 is machine readable code that when accessed or activated indicates that the compliant virtual asset includes the one or more required virtual asset characteristics.

In one embodiment, once, one or more required virtual asset characteristics that are required to be associated with all virtual assets deployed in the dedicated hosting environment are defined, and required virtual asset characteristic certification data is generated at DEFINE ONE OR MORE REQUIRED VIRTUAL ASSET CHARACTERISTICS THAT ARE REQUIRED TO BE ASSOCIATED WITH ALL VIRTUAL ASSETS DEPLOYED IN THE DEDICATED HOSTING ENVIRONMENT OPERATION 405, process flow proceeds to PROVIDE EACH VIRTUAL ASSET DEPLOYED IN THE DEDICATED HOSTING ENVIRONMENT REQUIRED VIRTUAL ASSET CHARACTERISTIC CERTIFICATION DATA INDICATING THAT THE VIRTUAL ASSET INCLUDES THE ONE OR MORE REQUIRED VIRTUAL ASSET CHARACTERISTICS OPERATION 407.

In one embodiment, at PROVIDE EACH VIRTUAL ASSET DEPLOYED IN THE DEDICATED HOSTING ENVIRONMENT REQUIRED VIRTUAL ASSET CHARACTERISTIC CERTIFICATION DATA INDICATING THAT THE VIRTUAL ASSET INCLUDES THE ONE OR MORE REQUIRED VIRTUAL ASSET CHARACTERISTICS OPERATION 407, each virtual asset deployed in the dedicated hosting environment of PROVIDE A DEDICATED HOSTING ENVIRONMENT OPERATION 403 is provided the required virtual asset characteristic certification data of DEFINE ONE OR MORE REQUIRED VIRTUAL ASSET CHARACTERISTICS THAT ARE REQUIRED TO BE ASSOCIATED WITH ALL VIRTUAL ASSETS DEPLOYED IN THE DEDICATED HOSTING ENVIRONMENT OPERATION 405 indicating that the virtual asset includes the one or more required virtual asset characteristics.

In one embodiment, at PROVIDE EACH VIRTUAL ASSET DEPLOYED IN THE DEDICATED HOSTING ENVIRONMENT REQUIRED VIRTUAL ASSET CHARACTERISTIC CERTIFICATION DATA INDICATING THAT THE VIRTUAL ASSET INCLUDES THE ONE OR MORE REQUIRED VIRTUAL ASSET CHARACTERISTICS OPERATION 407 compliant virtual assets are instantiated for deployment in the dedicated hosting environment.

In various embodiments the compliant virtual assets to be deployed in the dedicated hosting environment of PROVIDE EACH VIRTUAL ASSET DEPLOYED IN THE DEDICATED HOSTING ENVIRONMENT REQUIRED VIRTUAL ASSET CHARACTERISTIC CERTIFICATION DATA INDICATING THAT THE VIRTUAL ASSET INCLUDES THE ONE OR MORE REQUIRED VIRTUAL ASSET CHARACTERISTICS OPERATION 407 are any of the virtual assets discussed herein, and/or as known in the art at the time of filing, and/or as developed after the time of filing.

In one embodiment, each of the compliant virtual assets instantiated for deployment in the dedicated hosting environment is provided the required virtual asset characteristic certification data indicating that the virtual asset includes the one or more required virtual asset characteristics at PROVIDE EACH VIRTUAL ASSET DEPLOYED IN THE DEDICATED HOSTING ENVIRONMENT REQUIRED VIRTUAL ASSET CHARACTERISTIC CERTIFICATION DATA INDICATING THAT THE VIRTUAL ASSET INCLUDES THE ONE OR MORE REQUIRED VIRTUAL ASSET CHARACTERISTICS OPERATION 407.

In one embodiment, at PROVIDE EACH VIRTUAL ASSET DEPLOYED IN THE DEDICATED HOSTING ENVIRONMENT REQUIRED VIRTUAL ASSET CHARACTERISTIC CERTIFICATION DATA INDICATING THAT THE VIRTUAL ASSET INCLUDES THE ONE OR MORE REQUIRED VIRTUAL ASSET CHARACTERISTICS OPERATION 407 each of the compliant virtual assets instantiated for deployment in the dedicated hosting environment is provided the required virtual asset characteristic certification data indicating that the virtual asset includes the one or more required virtual asset characteristics as metadata that can be accessed and read by the dedicated hosting environment user/dedicated hosting environment owner.

In one embodiment, at PROVIDE EACH VIRTUAL ASSET DEPLOYED IN THE DEDICATED HOSTING ENVIRONMENT REQUIRED VIRTUAL ASSET CHARACTERISTIC CERTIFICATION DATA INDICATING THAT THE VIRTUAL ASSET INCLUDES THE ONE OR MORE REQUIRED VIRTUAL ASSET CHARACTERISTICS OPERATION 407 each of the compliant virtual assets instantiated for deployment in the dedicated hosting environment is provided the required virtual asset characteristic certification data indicating that the virtual asset includes the one or more required virtual asset characteristics as part of virtual asset reporting data included in virtual asset reporting logic and data provided to the compliant virtual assets using a compliant virtual asset creation template.

In one embodiment, once each virtual asset deployed in the dedicated hosting environment of PROVIDE A DEDICATED HOSTING ENVIRONMENT OPERATION 403 is provided the required virtual asset characteristic certification data of DEFINE ONE OR MORE REQUIRED VIRTUAL ASSET CHARACTERISTICS THAT ARE REQUIRED TO BE ASSOCIATED WITH ALL VIRTUAL ASSETS DEPLOYED IN THE DEDICATED HOSTING ENVIRONMENT OPERATION 405 indicating that the virtual asset includes the one or more required virtual asset characteristics at PROVIDE EACH VIRTUAL ASSET DEPLOYED IN THE DEDICATED HOSTING ENVIRONMENT REQUIRED VIRTUAL ASSET CHARACTERISTIC CERTIFICATION DATA INDICATING THAT THE VIRTUAL ASSET INCLUDES THE ONE OR MORE REQUIRED VIRTUAL ASSET CHARACTERISTICS OPERATION 407, process flow proceeds to PROVIDE A VIRTUAL ASSET MONITORING SYSTEM CAPABLE OF OBTAINING AND/OR READING THE REQUIRED VIRTUAL ASSET CHARACTERISTIC CERTIFICATION DATA OPERATION 409.

In one embodiment, at PROVIDE A VIRTUAL ASSET MONITORING SYSTEM CAPABLE OF OBTAINING AND/OR READING THE REQUIRED VIRTUAL ASSET CHARACTERISTIC CERTIFICATION DATA OPERATION 409, a virtual asset monitoring system is provided.

In one embodiment, at PROVIDE A VIRTUAL ASSET MONITORING SYSTEM CAPABLE OF OBTAINING AND/OR READING THE REQUIRED VIRTUAL ASSET CHARACTERISTIC CERTIFICATION DATA OPERATION 409, a virtual asset monitoring system is provided that is capable of obtaining and/or reading the required virtual asset characteristic certification data of PROVIDE EACH VIRTUAL ASSET DEPLOYED IN THE DEDICATED HOSTING ENVIRONMENT REQUIRED VIRTUAL ASSET CHARACTERISTIC CERTIFICATION DATA INDICATING THAT THE VIRTUAL ASSET INCLUDES THE ONE OR MORE REQUIRED VIRTUAL ASSET CHARACTERISTICS OPERATION 407.

In one embodiment, the virtual asset monitoring system of PROVIDE A VIRTUAL ASSET MONITORING SYSTEM CAPABLE OF OBTAINING AND/OR READING THE REQUIRED VIRTUAL ASSET CHARACTERISTIC CERTIFICATION DATA OPERATION 409 is used to monitor each virtual asset deployed in the dedicated hosting environment of PROVIDE A DEDICATED HOSTING ENVIRONMENT OPERATION 403 to ensure that each virtual asset in the dedicated hosting environment includes the required virtual asset characteristic certification data of PROVIDE EACH VIRTUAL ASSET DEPLOYED IN THE DEDICATED HOSTING ENVIRONMENT REQUIRED VIRTUAL ASSET CHARACTERISTIC CERTIFICATION DATA INDICATING THAT THE VIRTUAL ASSET INCLUDES THE ONE OR MORE REQUIRED VIRTUAL ASSET CHARACTERISTICS OPERATION 407, i.e., is a compliant virtual asset.

In one embodiment, the virtual asset monitoring system of PROVIDE A VIRTUAL ASSET MONITORING SYSTEM CAPABLE OF OBTAINING AND/OR READING THE REQUIRED VIRTUAL ASSET CHARACTERISTIC CERTIFICATION DATA OPERATION 409 is implemented in the dedicated hosting environment in which the virtual assets are instantiated and deployed.

In one embodiment, the virtual asset monitoring system of PROVIDE A VIRTUAL ASSET MONITORING SYSTEM CAPABLE OF OBTAINING AND/OR READING THE REQUIRED VIRTUAL ASSET CHARACTERISTIC CERTIFICATION DATA OPERATION 409 is implemented in a computing environment that is distinct from the dedicated hosting environment in which the virtual assets are instantiated and deployed.

In one embodiment, the virtual asset monitoring system of PROVIDE A VIRTUAL ASSET MONITORING SYSTEM CAPABLE OF OBTAINING AND/OR READING THE REQUIRED VIRTUAL ASSET CHARACTERISTIC CERTIFICATION DATA OPERATION 409 is implemented, at least in part, in a data center associated with the dedicated hosting environment user/dedicated hosting environment owner.

In various embodiments, the virtual asset monitoring system of PROVIDE A VIRTUAL ASSET MONITORING SYSTEM CAPABLE OF OBTAINING AND/OR READING THE REQUIRED VIRTUAL ASSET CHARACTERISTIC CERTIFICATION DATA OPERATION 409 is implemented in software, hardware, and/or a combination of software and hardware.

In one embodiment, the virtual asset monitoring system of PROVIDE A VIRTUAL ASSET MONITORING SYSTEM CAPABLE OF OBTAINING AND/OR READING THE REQUIRED VIRTUAL ASSET CHARACTERISTIC CERTIFICATION DATA OPERATION 409 is a hypervisor, or similar system, for monitoring and/or managing a computing environment and the assets associated with the computing environment.

In one embodiment, once a virtual asset monitoring system is provided that is capable of obtaining and/or reading the required virtual asset characteristic certification data of PROVIDE EACH VIRTUAL ASSET DEPLOYED IN THE DEDICATED HOSTING ENVIRONMENT REQUIRED VIRTUAL ASSET CHARACTERISTIC CERTIFICATION DATA INDICATING THAT THE VIRTUAL ASSET INCLUDES THE ONE OR MORE REQUIRED VIRTUAL ASSET CHARACTERISTICS OPERATION 407 at PROVIDE A VIRTUAL ASSET MONITORING SYSTEM CAPABLE OF OBTAINING AND/OR READING THE REQUIRED VIRTUAL ASSET CHARACTERISTIC CERTIFICATION DATA OPERATION 409, process flow proceeds to USE THE VIRTUAL ASSET MONITORING SYSTEM TO MONITOR EACH VIRTUAL ASSET DEPLOYED IN THE DEDICATED HOSTING ENVIRONMENT TO ENSURE THAT EACH VIRTUAL ASSET IN THE DEDICATED HOSTING ENVIRONMENT INCLUDES THE REQUIRED VIRTUAL ASSET CHARACTERISTIC CERTIFICATION DATA OPERATION 411.

In one embodiment, at USE THE VIRTUAL ASSET MONITORING SYSTEM TO MONITOR EACH VIRTUAL ASSET DEPLOYED IN THE DEDICATED HOSTING ENVIRONMENT TO ENSURE THAT EACH VIRTUAL ASSET IN THE DEDICATED HOSTING ENVIRONMENT INCLUDES THE REQUIRED VIRTUAL ASSET CHARACTERISTIC CERTIFICATION DATA OPERATION 411 the virtual asset monitoring system of PROVIDE A VIRTUAL ASSET MONITORING SYSTEM CAPABLE OF OBTAINING AND/OR READING THE REQUIRED VIRTUAL ASSET CHARACTERISTIC CERTIFICATION DATA OPERATION 409 is used to monitor each virtual asset deployed in the dedicated hosting environment of PROVIDE A DEDICATED HOSTING ENVIRONMENT OPERATION 403 to ensure that each virtual asset in the dedicated hosting environment includes the required virtual asset characteristic certification data of PROVIDE EACH VIRTUAL ASSET DEPLOYED IN THE DEDICATED HOSTING ENVIRONMENT REQUIRED VIRTUAL ASSET CHARACTERISTIC CERTIFICATION DATA INDICATING THAT THE VIRTUAL ASSET INCLUDES THE ONE OR MORE REQUIRED VIRTUAL ASSET CHARACTERISTICS OPERATION 407.

In one embodiment, at USE THE VIRTUAL ASSET MONITORING SYSTEM TO MONITOR EACH VIRTUAL ASSET DEPLOYED IN THE DEDICATED HOSTING ENVIRONMENT TO ENSURE THAT EACH VIRTUAL ASSET IN THE DEDICATED HOSTING ENVIRONMENT INCLUDES THE REQUIRED VIRTUAL ASSET CHARACTERISTIC CERTIFICATION DATA OPERATION 411 the virtual asset monitoring system monitors each virtual asset deployed in the dedicated hosting environment by checking metadata associated with the virtual assets in the dedicated hosting environment including the required virtual asset characteristic certification data.

In one embodiment, at USE THE VIRTUAL ASSET MONITORING SYSTEM TO MONITOR EACH VIRTUAL ASSET DEPLOYED IN THE DEDICATED HOSTING ENVIRONMENT TO ENSURE THAT EACH VIRTUAL ASSET IN THE DEDICATED HOSTING ENVIRONMENT INCLUDES THE REQUIRED VIRTUAL ASSET CHARACTERISTIC CERTIFICATION DATA OPERATION 411 the virtual asset monitoring system monitors each virtual asset deployed in the dedicated hosting environment by generating a challenge for each virtual asset deployed in the dedicated hosting environment and receiving response data including the required virtual asset characteristic certification data.

In one embodiment, at USE THE VIRTUAL ASSET MONITORING SYSTEM TO MONITOR EACH VIRTUAL ASSET DEPLOYED IN THE DEDICATED HOSTING ENVIRONMENT TO ENSURE THAT EACH VIRTUAL ASSET IN THE DEDICATED HOSTING ENVIRONMENT INCLUDES THE REQUIRED VIRTUAL ASSET CHARACTERISTIC CERTIFICATION DATA OPERATION 411 the virtual asset monitoring system monitors each virtual asset deployed in the dedicated hosting environment by any one of numerous methods, means, mechanisms, and systems known in the art for obtaining data related to a virtual asset, as discussed herein, and/or as known in the art at the time of filing, and/or as developed after the time of filing.

In one embodiment, at USE THE VIRTUAL ASSET MONITORING SYSTEM TO MONITOR EACH VIRTUAL ASSET DEPLOYED IN THE DEDICATED HOSTING ENVIRONMENT TO ENSURE THAT EACH VIRTUAL ASSET IN THE DEDICATED HOSTING ENVIRONMENT INCLUDES THE REQUIRED VIRTUAL ASSET CHARACTERISTIC CERTIFICATION DATA OPERATION 411 the virtual asset monitoring system monitors each virtual asset deployed in the dedicated hosting environment on a relatively continuous basis. In one embodiment, the virtual asset monitoring system monitors each virtual asset deployed in the dedicated hosting environment on a defined periodic basis. In one embodiment, the virtual asset monitoring system monitors each virtual asset deployed in the dedicated hosting environment upon the occurrence of one or more trigger events, such as the instantiation of a new virtual asset in the dedicated hosting environment or in response to a call from a virtual asset in the dedicated hosting environment. In one embodiment, the virtual asset monitoring system monitors each virtual asset on an on demand basis.

In one embodiment, at USE THE VIRTUAL ASSET MONITORING SYSTEM TO MONITOR EACH VIRTUAL ASSET DEPLOYED IN THE DEDICATED HOSTING ENVIRONMENT TO ENSURE THAT EACH VIRTUAL ASSET IN THE DEDICATED HOSTING ENVIRONMENT INCLUDES THE REQUIRED VIRTUAL ASSET CHARACTERISTIC CERTIFICATION DATA OPERATION 411 the virtual asset monitoring system monitoring each virtual asset deployed in the dedicated hosting environment results in the creation of a required virtual asset characteristic compliance log that includes required virtual asset characteristic compliance log data.

In one embodiment, the required virtual asset characteristic compliance log data indicates the compliance or non-compliance state of each virtual asset deployed in the dedicated hosting environment.

In one embodiment, the required virtual asset characteristic compliance log data is then analyzed at USE THE VIRTUAL ASSET MONITORING SYSTEM TO MONITOR EACH VIRTUAL ASSET DEPLOYED IN THE DEDICATED HOSTING ENVIRONMENT TO ENSURE THAT EACH VIRTUAL ASSET IN THE DEDICATED HOSTING ENVIRONMENT INCLUDES THE REQUIRED VIRTUAL ASSET CHARACTERISTIC CERTIFICATION DATA OPERATION 411 on a relatively continuous, periodic, trigger event occurrence, or on-demand basis.

In one embodiment, once the virtual asset monitoring system of PROVIDE A VIRTUAL ASSET MONITORING SYSTEM CAPABLE OF OBTAINING AND/OR READING THE REQUIRED VIRTUAL ASSET CHARACTERISTIC CERTIFICATION DATA OPERATION 409 is used to monitor each virtual asset deployed in the dedicated hosting environment of PROVIDE A DEDICATED HOSTING ENVIRONMENT OPERATION 403 to ensure that each virtual asset in the dedicated hosting environment includes the required virtual asset characteristic certification data of PROVIDE EACH VIRTUAL ASSET DEPLOYED IN THE DEDICATED HOSTING ENVIRONMENT REQUIRED VIRTUAL ASSET CHARACTERISTIC CERTIFICATION DATA INDICATING THAT THE VIRTUAL ASSET INCLUDES THE ONE OR MORE REQUIRED VIRTUAL ASSET CHARACTERISTICS OPERATION 407 at USE THE VIRTUAL ASSET MONITORING SYSTEM TO MONITOR EACH VIRTUAL ASSET DEPLOYED IN THE DEDICATED HOSTING ENVIRONMENT TO ENSURE THAT EACH VIRTUAL ASSET IN THE DEDICATED HOSTING ENVIRONMENT INCLUDES THE REQUIRED VIRTUAL ASSET CHARACTERISTIC CERTIFICATION DATA OPERATION 411, process flow proceeds to IF A NON-COMPLIANT VIRTUAL ASSET IS IDENTIFIED IN THE DEDICATED HOSTING ENVIRONMENT, ALERT ONE OR MORE ENTITIES OF THE NON-COMPLIANT VIRTUAL ASSET OPERATION 413.

In one embodiment, at IF A NON-COMPLIANT VIRTUAL ASSET IS IDENTIFIED IN THE DEDICATED HOSTING ENVIRONMENT, ALERT ONE OR MORE ENTITIES OF THE NON-COMPLIANT VIRTUAL ASSET OPERATION 413 if, as a result of the monitoring at USE THE VIRTUAL ASSET MONITORING SYSTEM TO MONITOR EACH VIRTUAL ASSET DEPLOYED IN THE DEDICATED HOSTING ENVIRONMENT TO ENSURE THAT EACH VIRTUAL ASSET IN THE DEDICATED HOSTING ENVIRONMENT INCLUDES THE REQUIRED VIRTUAL ASSET CHARACTERISTIC CERTIFICATION DATA OPERATION 411, a virtual asset is identified in the dedicated hosting environment of PROVIDE A DEDICATED HOSTING ENVIRONMENT OPERATION 403 that does not include the required virtual asset characteristic certification data of PROVIDE EACH VIRTUAL ASSET DEPLOYED IN THE DEDICATED HOSTING ENVIRONMENT REQUIRED VIRTUAL ASSET CHARACTERISTIC CERTIFICATION DATA INDICATING THAT THE VIRTUAL ASSET INCLUDES THE ONE OR MORE REQUIRED VIRTUAL ASSET CHARACTERISTICS OPERATION 407, that virtual assert is determined to be a non-compliant virtual asset and an alert is provided to one or more entities of the non-compliant virtual asset.

In one embodiment, once any virtual asset is identified in the dedicated hosting environment that does not include the required virtual asset characteristic certification data is determined to be a non-compliant virtual asset, and an alert is provided to one or more entities of the non-compliant virtual asset, at IF A NON-COMPLIANT VIRTUAL ASSET IS IDENTIFIED IN THE DEDICATED HOSTING ENVIRONMENT, ALERT ONE OR MORE ENTITIES OF THE NON-COMPLIANT VIRTUAL ASSET OPERATION 413, process flow proceeds to EXIT OPERATION 430.

In one embodiment, at EXIT OPERATION 430 process 400 for detecting irregularities and vulnerabilities in dedicated hosting environments is exited to await new data.

Using process 400 for detecting irregularities and vulnerabilities in dedicated hosting environments, virtual assets deployed in a dedicated hosting environment are automatically monitored to positively establish that the virtual assets deployed in the dedicated hosting environment are only virtual assets controlled by a designated owner/user of the dedicated hosting environment and that those virtual assets have the operational and security characteristics and features the designated dedicated hosting environment owner/user requires. Consequently, using process 400 for detecting irregularities and vulnerabilities in dedicated hosting environments, a designated owner/user of a dedicated hosting environment can ensure his or her dedicated hosting environment is providing the security level required and is providing the full benefits associated with, and expected from, dedicated hosting environments.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

As discussed in more detail above, using the above embodiments, with little or no modification and/or input, there is considerable flexibility, adaptability, and opportunity for customization to meet the specific needs of various parties under numerous circumstances.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, or protocols. Further, the system or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic or algorithm-like descriptions and representations are the means used by those of skill in the art to most effectively and efficiently convey the substance of their work to others of skill in the art. These operations, while described functionally or logically, are understood to be implemented by computer programs or computing systems. Furthermore, it has also proven convenient at times to refer to these arrangements of operations as steps or modules or by functional names, without loss of generality.

Unless specifically stated otherwise, as would be apparent from the above discussion, it is appreciated that throughout the above description, discussions utilizing terms such as, but not limited to, “activating”, “accessing”, “aggregating”, “alerting”, “applying”, “analyzing”, “associating”, “calculating”, “capturing”, “categorizing”, “classifying”, “comparing”, “creating”, “defining”, “detecting”, “determining”, “distributing”, “encrypting”, “extracting”, “filtering”, “forwarding”, “generating”, “identifying”, “implementing”, “informing”, “monitoring”, “obtaining”, “posting”, “processing”, “providing”, “receiving”, “requesting”, “saving”, “sending”, “storing”, “transferring”, “transforming”, “transmitting”, “using”, etc., refer to the action and process of a computing system or similar electronic device that manipulates and operates on data represented as physical (electronic) quantities within the computing system memories, resisters, caches or other information storage, transmission or display devices.

The present invention also relates to an apparatus or system for performing the operations described herein. This apparatus or system may be specifically constructed for the required purposes, or the apparatus or system can comprise a general purpose system selectively activated or configured/reconfigured by a computer program stored on a computer program product as discussed herein that can be accessed by a computing system or other device.

Those of skill in the art will readily recognize that the algorithms and operations presented herein are not inherently related to any particular computing system, computer architecture, computer or industry standard, or any other specific apparatus. Various general purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only.

The present invention is well suited to a wide variety of computer network systems operating over numerous topologies. Within this field, the configuration and management of large networks comprise storage devices and computers that are communicatively coupled to similar or dissimilar computers and storage devices over a private network, a LAN, a WAN, a private network, or a public network, such as the Internet.

It should also be noted that the language used in the specification has been principally selected for readability, clarity and instructional purposes, and may not have been selected to delineate or circumscribe the inventive subject matter. Accordingly, the disclosure of the present invention is intended to be illustrative, but not limiting, of the scope of the invention, which is set forth in the claims below.

In addition, the operations shown in the FIG.s, or as discussed herein, are identified using a particular nomenclature for ease of description and understanding, but other nomenclature is often used in the art to identify equivalent operations.

Therefore, numerous variations, whether explicitly provided for by the specification or implied by the specification or not, may be implemented by one of skill in the art in view of this disclosure.

What is claimed is:

1. A method for detecting irregularities and vulnerabilities in dedicated hosting environments comprising:
providing a dedicated hosting environment;
defining one or more required virtual asset characteristics that are required to be associated with all virtual assets deployed in the dedicated hosting environment;
providing each virtual asset deployed in the dedicated hosting environment required virtual asset characteristic certification data indicating that the virtual asset includes the one or more required virtual asset characteristics;
providing a virtual asset monitoring system capable of obtaining and/or reading the required virtual asset characteristic certification data;
using the virtual asset monitoring system to monitor each virtual asset deployed in the dedicated hosting environment to ensure that each virtual asset in the dedicated hosting environment includes the required virtual asset characteristic certification data; and
if a non-compliant virtual asset is identified in the dedicated hosting environment, alerting one or more entities of the non-compliant virtual asset.

2. The method for detecting irregularities and vulnerabilities in dedicated hosting environments of claim 1 wherein the dedicated hosting environment comprises a portion of one or more hardware systems dedicated to the deployment and operation of the one or more virtual assets.

3. The method for detecting irregularities and vulnerabilities in dedicated hosting environments of claim 1 wherein the dedicated hosting environment comprises one or more processing systems dedicated to the deployment and operation of the one or more virtual assets.

4. The method for detecting irregularities and vulnerabilities in dedicated hosting environments of claim 1 wherein the dedicated hosting environment comprises one or more server systems dedicated to the deployment and operation of the one or more virtual assets.

5. The method for detecting irregularities and vulnerabilities in dedicated hosting environments of claim 1 wherein the dedicated hosting environment comprises dedicated virtual assets.

6. The method for detecting irregularities and vulnerabilities in dedicated hosting environments of claim 1 wherein the virtual asset monitoring system is implemented, at least in part, in a first computing environment and the dedicated hosting environment is implemented, at least in part, in a second computing environment, the second computing environment being distinct from the first computing environment.

7. The method for detecting irregularities and vulnerabilities in dedicated hosting environments of claim 1 wherein at least one of the one or more virtual assets is a virtual asset selected from the group of the virtual assets consisting of:
a virtual machine;
a virtual server;
a database or data store;
an instance in a cloud environment;
a cloud environment access system;
part of a mobile device;
part of a remote sensor;
part of a server computing system; and
part of a desktop computing system.

8. The method for detecting irregularities and vulnerabilities in dedicated hosting environments of claim 1 wherein at least one of the one or more required virtual asset characteristics that are required to be associated with all virtual assets deployed in the dedicated hosting environment is selected form the group of required virtual asset characteristics consisting of:
the required virtual asset characteristic that the virtual assets be hosted virtual assets dedicated for use by a defined entity;
the required virtual asset characteristic that the virtual assets be of a defined virtual asset class;
the required virtual asset characteristic that the virtual assets have a defined functionality;
the required virtual asset characteristic that the virtual assets have one or more defined capabilities;
the required virtual asset characteristic that the virtual assets be self-monitoring virtual assets;
the required virtual asset characteristic that the virtual assets be self-reporting virtual assets;
the required virtual asset characteristic that the virtual assets be self-healing virtual assets;
the required virtual asset characteristic that the virtual assets be hardened virtual assets; and
the required virtual asset characteristic that the virtual assets be virtual assets instantiated to include one or more defined security features.

9. The method for detecting irregularities and vulnerabilities in dedicated hosting environments of claim 1 wherein the required virtual asset characteristic certification data is metadata associated with the one or more virtual assets.

10. The method for detecting irregularities and vulnerabilities in dedicated hosting environments of claim 1 wherein the required virtual asset characteristic certification data is challenge response data associated with the one or more virtual assets provided in response to receipt of challenge data from the virtual asset monitoring system.

11. The method for detecting irregularities and vulnerabilities in dedicated hosting environments of claim 1 wherein the virtual asset monitoring system is a hypervisor capable of obtaining and/or reading the required virtual asset characteristic certification data from each virtual asset in the dedicated hosting environment.

12. The method for detecting irregularities and vulnerabilities in dedicated hosting environments of claim 1 wherein the monitoring system generates virtual asset compliance log data indicating whether each virtual asset deployed in the dedicated hosting environment includes the required virtual asset characteristic certification data.

13. The method for detecting irregularities and vulnerabilities in dedicated hosting environments of claim 12 wherein a non-compliant virtual asset is identified by automatically analyzing the generated virtual asset compliance log data on a periodic basis.

14. The method for detecting irregularities and vulnerabilities in dedicated hosting environments of claim 12 wherein a non-compliant virtual asset is identified by automatically analyzing the generated virtual asset compliance log data in response to one or more trigger events.

15. The method for detecting irregularities and vulnerabilities in dedicated hosting environments of claim 14 wherein the one or more trigger events include a call issued to the virtual asset monitoring system by a virtual asset in the dedicated hosting environment.

16. The method for detecting irregularities and vulnerabilities in dedicated hosting environments of claim 12 wherein a non-compliant virtual asset is identified by analyzing the generated virtual asset compliance log data on an on-demand basis.

17. A system for detecting irregularities and vulnerabilities in dedicated hosting environments comprising:
at least one processor; and
at least one memory coupled to the at least one processor, the at least one memory having stored therein instructions which when executed by any set of the one or more processors, perform a process for detecting irregularities and vulnerabilities in dedicated hosting environments, the process for detecting irregularities and vulnerabilities in dedicated hosting environments including:
providing a dedicated hosting environment;
defining one or more required virtual asset characteristics that are required to be associated with all virtual assets deployed in the dedicated hosting environment;
providing each virtual asset deployed in the dedicated hosting environment required virtual asset characteristic certification data indicating that the virtual asset includes the one or more required virtual asset characteristics;
providing a virtual asset monitoring system capable of obtaining and/or reading the required virtual asset characteristic certification data;
using the virtual asset monitoring system to monitor each virtual asset deployed in the dedicated hosting environment to ensure that each virtual asset in the dedicated hosting environment includes the required virtual asset characteristic certification data; and
if a non-compliant virtual asset is identified in the dedicated hosting environment, alerting one or more entities of the non-compliant virtual asset.

18. The system for detecting irregularities and vulnerabilities in dedicated hosting environments of claim 17 wherein the dedicated hosting environment comprises a portion of one or more hardware systems dedicated to the deployment and operation of the one or more virtual assets.

19. The system for detecting irregularities and vulnerabilities in dedicated hosting environments of claim 17 wherein the dedicated hosting environment comprises one or more processing systems dedicated to the deployment and operation of the one or more virtual assets.

20. The system for detecting irregularities and vulnerabilities in dedicated hosting environments of claim 17 wherein the dedicated hosting environment comprises one or more server systems dedicated to the deployment and operation of the one or more virtual assets.

21. The system for detecting irregularities and vulnerabilities in dedicated hosting environments of claim 17 wherein the dedicated hosting environment comprises dedicated virtual assets.

22. The system for detecting irregularities and vulnerabilities in dedicated hosting environments of claim 17 wherein the virtual asset monitoring system is implemented, at least in part, in a first computing environment and the dedicated hosting environment is implemented, at least in part, in a second computing environment, the second computing environment being distinct from the first computing environment.

23. The system for detecting irregularities and vulnerabilities in dedicated hosting environments of claim 17 wherein at least one of the one or more virtual assets is a virtual asset selected from the group of the virtual assets consisting of:
a virtual machine;
a virtual server;
a database or data store;
an instance in a cloud environment;
a cloud environment access system;
part of a mobile device;
part of a remote sensor;
part of a server computing system; and
part of a desktop computing system.

24. The system for detecting irregularities and vulnerabilities in dedicated hosting environments of claim 17 wherein at least one of the one or more required virtual asset characteristics that are required to be associated with all virtual assets deployed in the dedicated hosting environment is selected form the group of required virtual asset characteristics consisting of:
the required virtual asset characteristic that the virtual assets be hosted virtual assets dedicated for use by a defined entity;
the required virtual asset characteristic that the virtual assets be of a defined virtual asset class;
the required virtual asset characteristic that the virtual assets have a defined functionality;
the required virtual asset characteristic that the virtual assets have one or more defined capabilities;
the required virtual asset characteristic that the virtual assets be self-monitoring virtual assets;
the required virtual asset characteristic that the virtual assets be self-reporting virtual assets;
the required virtual asset characteristic that the virtual assets be self-healing virtual assets;
the required virtual asset characteristic that the virtual assets be hardened virtual assets; and
the required virtual asset characteristic that the virtual assets be virtual assets instantiated to include one or more defined security features.

25. The system for detecting irregularities and vulnerabilities in dedicated hosting environments of claim 17 wherein the required virtual asset characteristic certification data is metadata associated with the one or more virtual assets.

26. The system for detecting irregularities and vulnerabilities in dedicated hosting environments of claim 17 wherein the required virtual asset characteristic certification data is challenge response data associated with the one or more virtual assets provided in response to receipt of challenge data from the virtual asset monitoring system.

27. The system for detecting irregularities and vulnerabilities in dedicated hosting environments of claim 17 wherein the virtual asset monitoring system is a hypervisor capable of obtaining and/or reading the required virtual asset characteristic certification data from each virtual asset in the dedicated hosting environment.

28. The system for detecting irregularities and vulnerabilities in dedicated hosting environments of claim 17 wherein the monitoring system generates virtual asset compliance log data indicating whether each virtual asset deployed in the dedicated hosting environment includes the required virtual asset characteristic certification data.

29. The system for detecting irregularities and vulnerabilities in dedicated hosting environments of claim 28 wherein a non-compliant virtual asset is identified by automatically analyzing the generated virtual asset compliance log data on a periodic basis.

30. The system for detecting irregularities and vulnerabilities in dedicated hosting environments of claim 28 wherein a non-compliant virtual asset is identified by automatically analyzing the generated virtual asset compliance log data in response to one or more trigger events.

31. The system for detecting irregularities and vulnerabilities in dedicated hosting environments of claim 30 wherein the one or more trigger events include a call issued to the virtual asset monitoring system by a virtual asset in the dedicated hosting environment.

32. The system for detecting irregularities and vulnerabilities in dedicated hosting environments of claim 28 wherein a non-compliant virtual asset is identified by analyzing the generated virtual asset compliance log data on an on-demand basis.

33. A system for detecting irregularities and vulnerabilities in dedicated hosting environments comprising:
a dedicated hosting environment;
one or more virtual assets deployed in the dedicated hosting environment;
a virtual asset monitoring system;
at least one processor; and
at least one memory coupled to the at least one processor, the at least one memory having stored therein instructions which when executed by any set of the one or more processors, perform a process for detecting irregularities and vulnerabilities in dedicated hosting environments, the process for detecting irregularities and vulnerabilities in dedicated hosting environments including:
defining one or more required virtual asset characteristics that are required to be associated with all of the virtual assets deployed in the dedicated hosting environment;
providing each of the virtual assets deployed in the dedicated hosting environment required virtual asset characteristic certification data indicating that the virtual asset includes the one or more required virtual asset characteristics;
using the virtual asset monitoring system to monitor each of the virtual assets deployed in the dedicated hosting environment to ensure that each of the virtual assets in the dedicated hosting environment includes the required virtual asset characteristic certification data; and
if a non-compliant virtual asset is identified in the dedicated hosting environment, alerting one or more entities of the non-compliant virtual asset.

34. The system for detecting irregularities and vulnerabilities in dedicated hosting environments of claim 33 wherein the dedicated hosting environment comprises a portion of one or more hardware systems dedicated to the deployment and operation of the one or more virtual assets.

35. The system for detecting irregularities and vulnerabilities in dedicated hosting environments of claim 33 wherein the dedicated hosting environment comprises one or more processing systems dedicated to the deployment and operation of the one or more virtual assets.

36. The system for detecting irregularities and vulnerabilities in dedicated hosting environments of claim 33 wherein the dedicated hosting environment comprises one or more server systems dedicated to the deployment and operation of the one or more virtual assets.

37. The system for detecting irregularities and vulnerabilities in dedicated hosting environments of claim 33 wherein the dedicated hosting environment comprises dedicated virtual assets.

38. The system for detecting irregularities and vulnerabilities in dedicated hosting environments of claim 33 wherein the virtual asset monitoring system is implemented, at least in part, in a first computing environment and the dedicated hosting environment is implemented, at least in part, in a second computing environment, the second computing environment being distinct from the first computing environment.

39. The system for detecting irregularities and vulnerabilities in dedicated hosting environments of claim 33 wherein at least one of the one or more virtual assets is a virtual asset selected from the group of the virtual assets consisting of:
a virtual machine;
a virtual server;
a database or data store;
an instance in a cloud environment;
a cloud environment access system;
part of a mobile device;
part of a remote sensor;
part of a server computing system; and
part of a desktop computing system.

40. The system for detecting irregularities and vulnerabilities in dedicated hosting environments of claim 33 wherein at least one of the one or more required virtual asset characteristics that are required to be associated with all virtual assets deployed in the dedicated hosting environment is selected form the group of required virtual asset characteristics consisting of:
the required virtual asset characteristic that the virtual assets be hosted virtual assets dedicated for use by a defined entity;
the required virtual asset characteristic that the virtual assets be of a defined virtual asset class;
the required virtual asset characteristic that the virtual assets have a defined functionality;
the required virtual asset characteristic that the virtual assets have one or more defined capabilities;
the required virtual asset characteristic that the virtual assets be self-monitoring virtual assets;
the required virtual asset characteristic that the virtual assets be self-reporting virtual assets;
the required virtual asset characteristic that the virtual assets be self-healing virtual assets;
the required virtual asset characteristic that the virtual assets be hardened virtual assets; and
the required virtual asset characteristic that the virtual assets be virtual assets instantiated to include one or more defined security features.

41. The system for detecting irregularities and vulnerabilities in dedicated hosting environments of claim 33 wherein the required virtual asset characteristic certification data is metadata associated with the one or more virtual assets.

42. The system for detecting irregularities and vulnerabilities in dedicated hosting environments of claim 33 wherein the required virtual asset characteristic certification data is challenge response data associated with the one or more virtual assets provided in response to receipt of challenge data from the virtual asset monitoring system.

43. The system for detecting irregularities and vulnerabilities in dedicated hosting environments of claim 33 wherein the virtual asset monitoring system is a hypervisor capable of obtaining and/or reading the required virtual asset characteristic certification data from each virtual asset in the dedicated hosting environment.

44. The system for detecting irregularities and vulnerabilities in dedicated hosting environments of claim 33 wherein the monitoring system generates virtual asset compliance log data indicating whether each virtual asset deployed in the dedicated hosting environment includes the required virtual asset characteristic certification data.

45. The system for detecting irregularities and vulnerabilities in dedicated hosting environments of claim 44 wherein a non-compliant virtual asset is identified by automatically analyzing the generated virtual asset compliance log data on a periodic basis.

46. The system for detecting irregularities and vulnerabilities in dedicated hosting environments of claim 44 wherein a non-compliant virtual asset is identified by automatically analyzing the generated virtual asset compliance log data in response to one or more trigger events.

47. The system for detecting irregularities and vulnerabilities in dedicated hosting environments of claim 46 wherein the one or more trigger events include a call issued to the virtual asset monitoring system by a virtual asset in the dedicated hosting environment.

48. The system for detecting irregularities and vulnerabilities in dedicated hosting environments of claim 44 wherein a non-compliant virtual asset is identified by analyzing the generated virtual asset compliance log data on an on-demand basis.

49. A system for detecting irregularities and vulnerabilities in cloud computing environments comprising:
at least one processor; and
at least one memory coupled to the at least one processor, the at least one memory having stored therein instructions which when executed by any set of the one or more processors, perform a process for detecting irregularities and vulnerabilities in cloud computing environments, the process for detecting irregularities and vulnerabilities in computing environments including:
providing a hosting environment;
defining one or more required virtual asset characteristics that are required to be associated with all virtual assets deployed in the cloud computing environment;
providing each virtual asset deployed in the cloud computing environment required virtual asset characteristic certification data indicating that the virtual asset includes the one or more required virtual asset characteristics;
providing a virtual asset monitoring system capable of obtaining and/or reading the required virtual asset characteristic certification data;
using the virtual asset monitoring system to monitor each virtual asset deployed in the cloud computing environment to ensure that each virtual asset in the cloud computing environment includes the required virtual asset characteristic certification data; and
if a non-compliant virtual asset is identified in the cloud computing environment, alerting one or more entities of the non-compliant virtual asset.

50. The system for detecting irregularities and vulnerabilities in cloud computing environments of claim 49 wherein at least one of the one or more virtual assets is a virtual asset selected from the group of the virtual assets consisting of:
a virtual machine;
a virtual server;
a database or data store;
an instance in a cloud environment;
a cloud environment access system;
part of a mobile device;
part of a remote sensor;
part of a server computing system; and
part of a desktop computing system.

51. The system for detecting irregularities and vulnerabilities in cloud computing environments of claim 49 wherein at least one of the one or more required virtual asset characteristics that are required to be associated with all virtual assets deployed in the cloud computing environment is selected form the group of required virtual asset characteristics consisting of:
the required virtual asset characteristic that the virtual assets be hosted virtual assets dedicated for use by a defined entity;
the required virtual asset characteristic that the virtual assets be of a defined virtual asset class;
the required virtual asset characteristic that the virtual assets have a defined functionality;
the required virtual asset characteristic that the virtual assets have one or more defined capabilities;
the required virtual asset characteristic that the virtual assets be self-monitoring virtual assets;
the required virtual asset characteristic that the virtual assets be self-reporting virtual assets;
the required virtual asset characteristic that the virtual assets be self-healing virtual assets;
the required virtual asset characteristic that the virtual assets be hardened virtual assets; and
the required virtual asset characteristic that the virtual assets be virtual assets instantiated to include one or more defined security features.

52. The system for detecting irregularities and vulnerabilities in cloud computing environments of claim 49 wherein the required virtual asset characteristic certification data is metadata associated with the one or more virtual assets.

53. The system for detecting irregularities and vulnerabilities in cloud computing environments of claim 49 wherein the required virtual asset characteristic certification data is challenge response data associated with the one or more virtual assets provided in response to receipt of challenge data from the virtual asset monitoring system.

54. The system for detecting irregularities and vulnerabilities in cloud computing environments of claim 49 wherein the virtual asset monitoring system is a hypervisor capable of obtaining and/or reading the required virtual asset characteristic certification data from each virtual asset in the cloud computing environment.

55. The system for detecting irregularities and vulnerabilities in cloud computing environments of claim 49 wherein the monitoring system generates virtual asset compliance log data indicating whether each virtual asset deployed in the cloud computing environment includes the required virtual asset characteristic certification data.

56. The system for detecting irregularities and vulnerabilities in cloud computing environments of claim 55 wherein a non-compliant virtual asset is identified by automatically analyzing the generated virtual asset compliance log data on a periodic basis.

57. The system for detecting irregularities and vulnerabilities in cloud computing environments of claim 55 wherein a non-compliant virtual asset is identified by automatically analyzing the generated virtual asset compliance log data in response to one or more trigger events.

58. The system for detecting irregularities and vulnerabilities in cloud computing environments of claim 57 wherein the one or more trigger events include a call issued to the virtual asset monitoring system by a virtual asset in the cloud computing environment.
